(19) United States
(12) Patent Application Publication
(10) Pub. No.: US 2009/0192280 A1
(43) Pub. Date: Jul. 30, 2009

(54) CELLULOSE ACYLATE FILM, SATURATED NORBORNENE RESIN FILM, AND PROCESS FOR PRODUCING THESE

(76) Inventor: Masaaki Otoshi, Shizuoka (JP)

Correspondence Address: YOUNG & THOMPSON, 209 Madison Street, Suite 500, ALEXANDRIA, VA, 22314, US

(21) Appl. No.: 12/302,580

(22) PCT Filed: May 24, 2007
(86) PCT No.: PCT/JP2007/060587

§ 371 Date: Nov. 26, 2008

(30) Foreign Application Priority Data
May 31, 2006 (JP) 2006-152219
Mar. 27, 2007 (JP) 2007-082012

(51) Int. Cl. C08F 132/08; B29C 47/88; C08B 3/00

(52) U.S. Cl. 526/281; 264/211.12; 536/63

(57) ABSTRACT

A high-quality cellulose acylate film and saturated norbornene resin film which are produced by a melt film formation method and can be inhibited from having steak failures. Also provided is a process for producing the cellulose acylate film or the saturated norbornene resin film. The process, which is for producing a cellulose acylate film (12) or a saturated norbornene resin film, comprises melting a cellulose acylate resin or saturated norbornene resin with an extruder (22), feeding the molten resin to a die (24) through a piping (23), and ejecting the melt in a sheet form from the die (24) onto a cooled support (26) which is running or rotating to thereby cool and solidify the sheet. Thus, a cellulose acylate film (12) or saturated norbornene resin film is formed. In the process, a static mixer (27) is disposed in the piping (23) and the molten resin flowing in the piping (23) is statically stirred.

### TECHNICAL FIELD

The present invention relates to a cellulose acylate film, a saturated norbornene resin film, and a process for producing these, and particularly relates to a technology for producing a cellulose acylate film and a saturated norbornene resin film which have preferable quality for a liquid crystal display device by a melt film-forming process.

### BACKGROUND ART

Cellulose acylate films and saturated norbornene resin films can be obtained by melting raw material resin pellets in an extruder, discharging the resultant melt resin in a sheet form from a die, cooling this on a cooling drum, and then peeling the sheet therefrom (e.g., see Patent Document 1). Further, it has been attempted to enlarge viewing angles by stretching a cellulose acylate film or a saturated norbornene resin film in the longitudinal direction (in the length direction) and the transverse direction (in the width direction) to exhibit in-plane retardation (Re) and retardation (Rth) in the thickness direction and use the film as a retardation film in liquid crystal display elements.

Patent Document 1: Japanese Patent Application Laid-Open No. 2000-352620

### DISCLOSURE OF THE INVENTION

However, when producing cellulose acylate films and saturated norbornene resin films, there was the problem that streaks occur in the formed film.

The present invention was created in view of the above-described circumstances. It is an object of the present invention to provide a cellulose acylate film, a saturated norbornene resin film, and a process for producing these, which can suppress the occurrence of streaking in a film, and which can produce a high-quality film.

To achieve the above-described object, a first aspect of the invention is a process for producing a cellulose acylate film, including melting a cellulose acylate resin in an extruder, supplying the melt resin to a die via a pipe, discharging the resin from the die in sheet form onto a running or a rotating cooling support, and quenching and solidifying the sheet so as to form the cellulose acylate film, the process comprising statically stirring the melt resin flowing through the pipe by providing a static mixer in the pipe.

As a result of intensive research into the causes of the occurrence of streaking in films, the present inventor discovered that temperature unevenness and viscosity unevenness of the melt resin in the pipe supplying the melt resin to the die from the extruder is a cause of streaking. Especially, compared with other thermoplastic resins, in a cellulose acylate resin, slight non-uniformities in temperature and viscosity in the melt state are a cause of streaking. Therefore, when forming a cellulose acylate film by a melt film-forming process, the occurrence of streaking in the film can be suppressed by reducing temperature unevenness and viscosity unevenness of the melt-state cellulose acylate resin. Further, the present inventor learned that temperature unevenness and viscosity unevenness can be reduced by providing a static mixer in the pipe which connects the extruder and the die.

According to the first aspect, in a process for producing a cellulose acylate film, since a static mixer is provided in a pipe so that the melt resin flowing through the pipe is statically stirred, temperature unevenness and viscosity unevenness of the melt resin can be reduced. As a result, the occurrence of streaking can be suppressed, whereby a cellulose acylate film can be produced having no plane defects and good plane quality. Therefore, a high-quality film can be produced.

A second aspect is characterized in that, in the first aspect, the static mixer has six or more elements.

According to the second aspect of the invention, since the static mixer has six or more elements, the melted cellulose acylate resin can be made to be uniform. Therefore, the occurrence of streaking in the produced cellulose acylate film can be suppressed. As the elements, it is preferred to use, for example, elements having a twisted blade shape.

A third aspect is characterized in that, in the first aspect or the second aspect, the pipe is provided with a filter apparatus comprising a leaf disc filter, and the filter apparatus is provided upstream of the static mixer.

According to the third aspect of the invention, since a filter apparatus comprising a leaf disc filter is provided in the pipe connecting the extruder and the die, although fine foreign matter can be removed, the melt resin is formed into branches as a result of the filter filtration, which becomes a cause of temperature unevenness and viscosity unevenness. In the third aspect, by providing the filter apparatus upstream of the static mixer, the flow history of the melt rein from the shaft hole of the filter apparatus (e.g., the formation of the melt resin into branches) can be made to be uniform by the downstream static mixer. Therefore, the occurrence of streaking in the produced cellulose acylate film can be suppressed.

A fourth aspect of the invention is a cellulose acylate film characterized in that the cellulose acylate film is produced by the production process of any of the first to third aspects.

A fifth aspect is characterized in that, in the fourth aspect, when X represents the degree of substitution of an acetyl group, and Y represents the sum of the degree of substitution of a propionyl group, a butyryl group, a pentanoyl group, and a hexanoyl group, the cellulose acylate resin of the fourth aspect has an acylate group which satisfies the following degree of substitution: 2.0≦X+Y≦3.0, 0≦X≦2.0 and 1.2≦Y≦2.9.

In the fifth aspect, characteristic values of a cellulose acylate film are defined which are suitable for use as a resinous film, such as a retardation film for a liquid crystal display element. A cellulose acylate film which satisfies this degree of substitution has a low melting point, is easily stretched, and has excellent moisture-proofing properties.

A sixth aspect of the invention is a process for producing a saturated norbornene resin film, including melting a saturated norbornene resin in an extruder, supplying the melt resin to a die via a pipe, discharging the resin from the die in sheet form onto a running or a rotating cooling support, and quenching and solidifying the sheet so as to form saturated norbornene resin film, the process comprising statically stirring the melt resin flowing through the pipe by providing a static mixer in the pipe. As a result of intensive research into the causes of the occurrence of streaking in films, the present inventor discovered that temperature unevenness and viscosity unevenness of the melt resin in the pipe supplying the melt resin to the die from the extruder is a cause of streaking. Especially, compared with other thermoplastic resins, saturated norbornene resins have a large melt viscosity temperature dependency, so that the viscosity changes with only a slight change in temperature, and this becomes a cause of streaking. Therefore, when forming a saturated norbornene resin film, comprising a melt film-forming process, the occurrence of streaking in the film can be suppressed by reducing temperature unevenness and viscosity unevenness of the melt-state saturated norbornene resin. Further, the present inventor learned that temperature unevenness and viscosity unevenness can be reduced by providing a static mixer in the pipe which connects the extruder and the die.

A seventh aspect is characterized in that the static mixer in the sixth aspect has six or more elements. Further, an eighth aspect is characterized in that the pipe in the sixth aspect or the seventh aspect is provided with a filter apparatus comprising a leaf disc filter, and the filter apparatus is provided upstream of the static mixer. Further, a ninth aspect is a saturated norbornene resin film characterized in that the film is produced by the production process of any of the sixth to eighth aspects.

According to the present invention, since the occurrence of streaking in a cellulose acylate film and a saturated norbornene resin film produced by a melt film-forming process can be suppressed, a high-quality cellulose acylate film and saturated norbornene resin film, and a process for producing these, can be provided.

### BRIEF DESCRIPTION OF THE DRAWINGS

FIG. 1 is an overall configuration view of a film producing apparatus applied by the present invention;

FIG. 2 is a schematic diagram illustrating the configuration of an extruder;

FIG. 3 is a schematic diagram illustrating the configuration of a filter apparatus;

FIG. 4 is a schematic diagram illustrating a metal filter member (leaf disc filter);

FIG. 5 is an explanatory diagram of examples of the present invention; and

FIG. 6 is an explanatory diagram of examples of the present invention.

### DESCRIPTION OF SYMBOLS

10 . . . Film producing apparatus, 12 . . . Cellulose acylate film, 14 . . . Film-forming processing section, 16 . . . Longitudinal stretching processing section, 18 . . . Transverse stretching processing section, 20 . . . Take up section, 22 . . . Extruder, 23 . . . Pipe, 24 . . . Die, 25 . . . Filter apparatus, 26 . . . Cooling drum, 27 . . . Static mixer, 27a . . . Element, 32 . . . Cylinder, 34 . . . Screw shaft, 36 . . . Screw blade, 38 . . . Screw, 40 . . . Feed port, 42 . . . Discharge port, 50 . . . Feed port, 52 . . . Extrusion port, 54 . . . Filter housing, 56 . . . Metal filter member (leaf disc filter), 58 . . . Filtration pathway, 60 . . . Shaft, 61 . . . Hole, 62 . . . Pathway

### BEST MODE FOR CARRYING OUT THE INVENTION

Preferred embodiments of the process for producing a cellulose acylate film according to the present invention will now be described with reference to the attached drawings. It is noted that the present invention is not only applied to a cellulose acylate film, and may also be similarly applied to a saturated norbornene resin film.

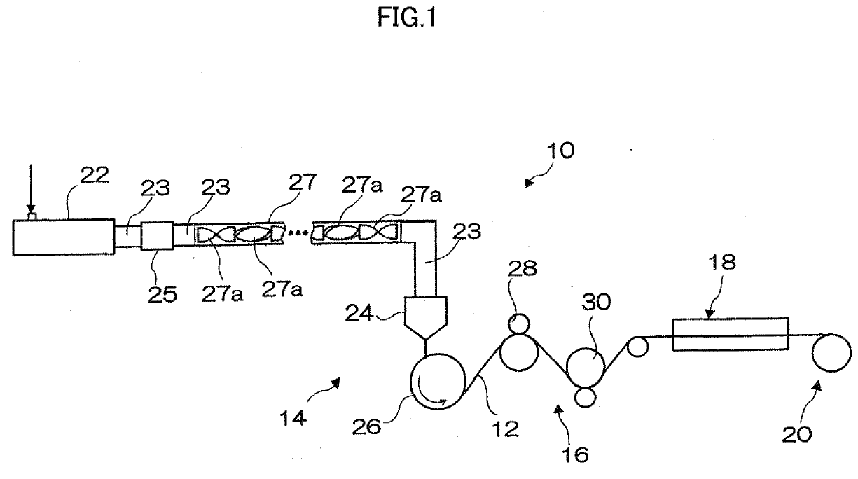

FIG. 1 illustrates one example of the basic structure of a cellulose acylate film producing apparatus. The film producing apparatus 10 illustrated in FIG. 1 is mainly configured from a film-forming processing section 14 which forms a pre-stretched cellulose acylate film 12, a longitudinal stretching processing section 16 which stretches the cellulose acylate film 12 formed by the film-forming processing section 14 in a longitudinal manner, a transverse stretching processing section 18 which stretches the cellulose acylate film 12 in a transverse manner, and a take up processing section 20 which takes up the stretched cellulose acylate film 12.

At the film-forming processing section 14, a cellulose acylate resin melted by an extruder 22 is discharged in sheet form from a die 24, is quenched and solidified by casting onto a rotating cooling drum 26 to obtain a cellulose acylate film 12. This cellulose acylate film 12 is peeled off from the cooling drum 26, and is then fed, in turn, to the longitudinal stretching processing section 16 and the transverse stretching processing section 18 and stretched. The resultant film is then taken up in a roll shape by the take up processing section 20 to thereby produce a stretched cellulose acylate film 12. Each of these processing sections will now be described in more detail.

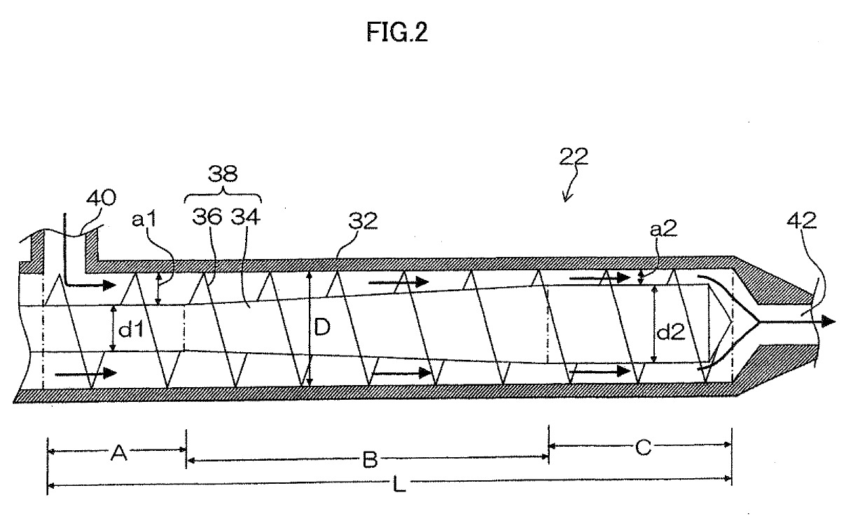

FIG. 2 illustrates the configuration of the extruder 22 of the film-forming processing section 14. As illustrated in FIG. 2, the extruder 22 is a single screw type extruder, in which a single screw 38 is provided in a cylinder 32. The single screw 38 is configured with a screw blade 36 attached to a screw shaft 34. The single screw 38 is supported in a freely-rotatable manner, and is driven by a (not shown) motor.

A jacket (not shown) is attached to the periphery of the cylinder 32, which allows the temperature to be controlled to a desired temperature.

A hopper (not shown) is attached to a feed port 40 of the cylinder 32. Pelletized cellulose acylate resin is fed from this hopper into the cylinder 32 via the feed port 40.

The cylinder 32 interior comprises, in order from the feed port 40, a feed section which conveys a fixed amount of cellulose acylate resin fed from the feed port 40 (region designated by A), a compression section which kneads and compresses the cellulose acylate resin (region designated by B), and a conveyance and metering section which meters the discharged amount of kneaded and compressed cellulose acylate resin while it is being conveyed to a discharge port 42 (region designated by C).

The screw compression ratio of the extruder 22 is set at 2.5 to 4.5, and L/D is set between 20 and 70. Here, “screw compression ratio” refers to the volume ratio of the feed section A to the metering section C, and is represented by: (volume per unit length of the feed section A)/(volume per unit length of the metering section C). This calculation uses the outer diameter d1 of the screw shaft 34 of the feed section A, the outer diameter d2 of the screw shaft 34 of the metering section C, the groove diameter a1 of the feed section A, and the groove diameter a2 of the metering section C. Further, L/D is the ratio of the cylinder 32 length (L) to the cylinder 32 bore diameter (D) in FIG. 2. The extrusion temperature is set at 190 to 240° C. In cases where the temperature in the extruder 22 exceeds 240° C., a cooler (not shown) may be provided between the extruder 22 and the die 24.

While the extruder 22 may be either a single-screw extruder or a twin-screw extruder, if the screw compression ratio is too small (below 2.5), the kneading cannot be carried out sufficiently, whereby unmelted portions can occur. As a result, shearing heat generation is small and melting of the crystals is insufficient, whereby fine crystals are more likely to remain in the cellulose acylate film after production and air bubbles are more likely to be mixed therein. As a consequence, when the cellulose acylate film 12 is stretched, the residual crystals inhibit the stretching performance, thereby rendering it impossible for the alignment to be sufficiently increased. On the other hand, if the screw compression ratio is too large (exceeding 4.5), the resin is more susceptible to degradation from heat due to too great a shearing stress being applied, whereby yellowing tends to appear in the produced cellulose acylate film. In addition, if too great a shearing stress is applied, the molecules are broken, whereby the molecular weight is reduced and the mechanical strength of the film is decreased. Therefore, to make it less likely for yellowing to appear on the film and less likely for stretching fractures to occur, the screw compression ratio is preferably in the range of 2.5 to 4.5, more preferably 2.8 to 4.2, and especially preferably 3.0 to 4.0.

If L/D is too small (below 20), the melting or kneading is insufficient, so that as is the case with when the compression ratio is too small, fine crystals are more likely to remain in the cellulose acylate film after production. On the other hand, if L/D is too large (exceeding 70), the residence time of the cellulose acylate resin in the extruder 22 is too long, whereby the resin is more susceptible to being degraded. In addition, if the residence time is longer, breaking of the molecules occurs, whereby the molecular weight is reduced and the mechanical strength of the film is decreased. Therefore, to make it less likely for yellowing to appear on the film and less likely for stretching fractures to occur, L/D is preferably in the range of 20 to 70, more preferably 22 to 45, and especially preferably 24 to 40.

If the extrusion temperature is too small (below 190° C.), the melting of the crystals is insufficient, whereby fine crystals are more likely to remain in the cellulose acylate film after production, so that when the cellulose acylate film is stretched, the stretching performance is inhibited, thereby rendering it impossible for the alignment to be sufficiently increased. On the other hand, if the extrusion temperature is too high (exceeding 240° C.), the cellulose acylate resin is degraded, and the yellowing (YI value) level worsens. Therefore, to make it less likely for yellowing to appear on the film and less likely for stretching fractures to occur, the extrusion temperature is preferably in the range of 190 to 240° C., more preferably 195 to 235° C., and especially preferably 200 to 230° C.

The cellulose acylate resin is melted by the thus-configured extruder 22, and that melt resin is continuously fed to the die 24 (see FIG. 1) via a pipe 23 from the discharge port 42.

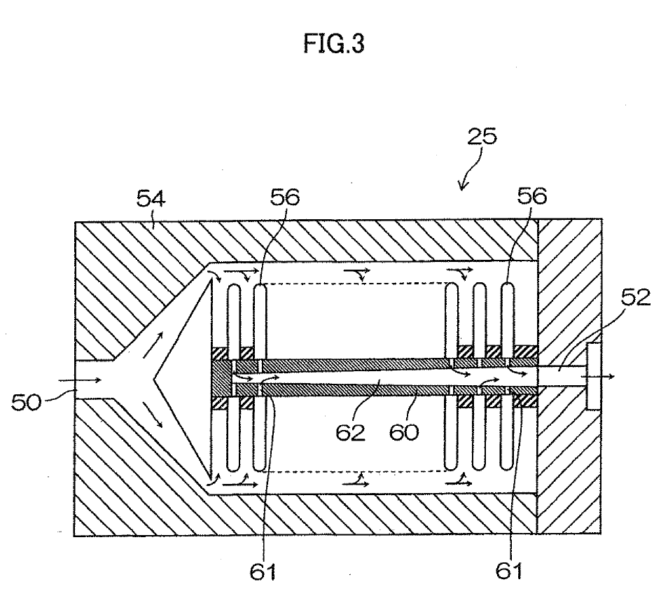

As illustrated in FIG. 1, it is preferred to have the filter apparatus 25 provided in the pipe 23. FIG. 3 is a schematic diagram illustrating the configuration of the filter apparatus 25. Here, the filter apparatus 25 is preferably arranged upstream of the below-described static mixer 27.

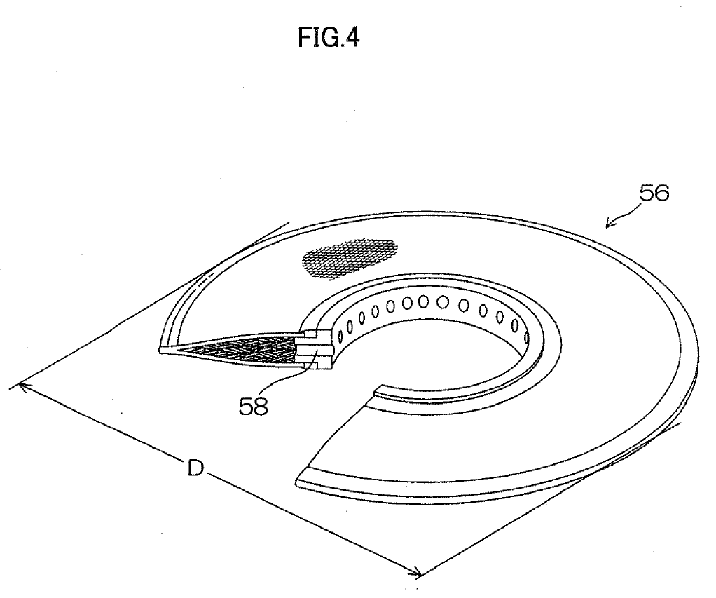

The filter apparatus 25 comprises mainly a cylindrical filter housing 54 having a feed port 50 and a extrusion port 52 for the melt resin, and a plurality of disc-shaped metal filter members (leaf disc filter) 56 provided in the filter housing 54. FIG. 4 is a schematic diagram illustrating the leaf disc filter 56. The leaf disc filter 56 has numerous holes of a 0.1 μm or more to 50 μm or less hole diameter. Further, a filtration pathway 58 so that the filtered melt resin flows in a pathway 62 is formed in the leaf disc filter 56. The diameter D etc. of the leaf disc filter 56 may be appropriately set according to the feed amount of melt resin from the extruder 22 and the residence time.

As a result, the melt resin melted by the extruder 22 is fed into the leaf disc filter 56 molded into a disc shape from the feed port 50. After the melt resin is filtered in the filtration pathway 58 from outside of the leaf disc filter 56, the melt resin passes through the pathway 62 via the holes 61 provided in the shaft 60, and is discharged from the extrusion port 52. Fine foreign matter is removed from the melt resin by this filter apparatus 25.

As illustrated in FIG. 1, a static mixer 27 is provided in the pipe 23. The static mixer 27 has elements 27a, 27a . . . which are rectangular plates twisted 180°. By passing the melted cellulose acylate resin through the pipe 23 of the thus-configured static mixer 27, the resin can be mixed. As a result, temperature unevenness and viscosity unevenness of the melt resin can be suppressed, so that the occurrence of streaking in the produced film 12 can be suppressed. Here, it is preferred to have six or more of the elements 27a of the static mixer 27. By having six or more elements 27a, the melt resin is divided up by 2⁶=64 or more. In addition, since the rotation direction changes for each element, the melt resin is subjected to rapid inversions of inertia, and is thus stirred in a turbulent manner, whereby the temperature unevenness and viscosity unevenness of the melt resin can be further suppressed.

Thus, in the melt film-forming of the cellulose acylate film 12, by providing a static mixer 27 in the pipe 23 to reduce the temperature unevenness and viscosity unevenness of the melt resin, the occurrence of streaking in the film 12 can be suppressed. As a result, a cellulose acylate film 12 can be produced having no plane defects and good plane quality. Therefore, a high-quality film can be produced. This is especially effective because, compared with other thermoplastic resins, in a cellulose acylate resin, slight non-uniformities in temperature and viscosity in the melt state are a cause of streaking.

Further, if the filter apparatus 25 configured by the pipe 23 connecting the extruder 22 and the die 24 and the leaf disc filter is provided, fine foreign matter in the melt resin can be effectively removed. By providing the filter apparatus 25 upstream of the static mixer 27, the flow history of the melt rein from the hole 61 of the shaft 60 of the filter apparatus 25 can be made to be uniform by the downstream static mixer 27. Therefore, the occurrence of streaking in the produced cellulose acylate film 12 can be suppressed.

The cellulose acylate film 12 formed by the film-forming processing section 14 is stretched by a longitudinal stretching processing section 16 and a transverse stretching processing section 18.

The stretching step will now be described as far as the cellulose acylate film 12 produced by the film-forming processing section 14 being stretched to produce a stretched cellulose acylate film 12.

Stretching of the cellulose acylate film 12 is performed by aligning the molecules in the cellulose acylate film 12 so that in-plane retardation Re and thickness direction retardation Rth are exhibited,

Here, retardation Re, Rth can be determined by the following equations.

Re(nm)=|n(MD)−n(TD)|×T(nm)

Rth(nm)=|{(n(MD)+n(TD))/2}−n(TH)|×T(nm)

In the equations, n(MD), n(TD) and n(TH) designate the refractive index of the longitudinal direction, width direction and thickness direction, and T designates thickness denoted in nm units.

As illustrated in FIG. 1, the cellulose acylate film 12 is first subjected to longitudinal stretching in the longitudinal direction by the longitudinal stretching processing section 16. At the longitudinal stretching processing section 16, the cellulose acylate film 12 is preheated, and then in this heated state the cellulose acylate film 12 is taken up onto two nip rollers 28, 30. The exit-side nip roller 30 conveys the cellulose acylate film 12 at a faster carrying rate than the entry-side nip roller 28, whereby the cellulose acylate film 12 is stretched in a longitudinal direction.

In the longitudinal stretching processing section 16, the preheating temperature is preferably Tg−40° C. or higher to Tg+60° C. or lower, more preferably Tg−20° C. or higher to Tg+40° C. or lower, and even more preferably Tg or higher to Tg+30° C. or lower. In the longitudinal stretching processing section 16, the stretching temperature is Tg or higher to Tg+60° C. or lower, more preferably Tg+2° C. or higher to Tg+40° C. or lower, and even more preferably Tg+5° C. or higher to Tg+30° C. or lower. The longitudinal stretching factor (stretching ratio) is preferably 1.0 or more to 2.5 or less, and further preferably 1.1 or more to 2 or less.

The longitudinally stretched cellulose acylate film 12 is moved to the transverse stretching processing section 18 to undergo transverse stretching in the width direction. At the transverse stretching processing section 18, a tenter for instance can be preferably used, wherein both ends in the width direction of the cellulose acylate film 12 are gripped with clips using this tenter, and stretched in the width direction. The retardation Rth can be greatly increased by this transverse stretching.

The transverse stretching is preferably carried out by means of the tenter, and the stretching temperature is preferably Tg or higher and Tg+60° C. or lower, more preferably Tg+2° C. or higher and Tg+40° C. or lower, and furthermore preferably Tg+4° C. or higher and Tg+30° C. or lower. The stretching factor is preferably 1.0 or more to 2.5 or less and further preferably 1.1 or more to 2.0 or less. It is preferable to carry out relief in either the longitudinal or the transverse direction, or in both directions, after the transverse stretching. Such relief can narrow the transverse distribution of the slow axis.

From such stretching, Re is 0 nm or more to 500 nm or less, more preferably 10 nm or more to 400 nm or less, and even more preferably 15 nm or more to 300 nm or less; and Rth is preferably 0 nm to 500 nm or less, more preferably 50 nm or more to 400 nm or less, and even more preferably 70 nm or more to 350 nm or less.

Within these ranges, it is preferable that Re is not greater than Rth (Re≦Rth), and more preferable that Re×2 is not greater than Rth (2Re≦Rth), To attain such a high Rth and low Re, it is preferable that as described above the longitudinally stretched film is stretched in a transverse (width) direction. Specifically, while the difference in alignment between the longitudinal direction and transverse direction alignment becomes the difference in in-plane retardation (Re), in addition to the longitudinal direction, by stretching in a transverse direction orthogonal to the longitudinal direction the difference in the longitudinal/transverse alignment is reduced, whereby the plane alignment (Re) can be reduced. On the other hand, by stretching transverse in addition to longitudinal, the area ratio increases. As a result, alignment in the thickness direction increases in conjunction with the reduction in thickness, whereby Rth can be increased.

The stretched cellulose acylate film 12 is taken up in a roll shape by the take up section 20 of FIG. 1. At that stage, the take-up tension of the cellulose acylate film 12 is preferably 0.02 kg/mm² or less. By setting the take-up tension in such a range, the taking up can be carried out without the occurrence of a retardation distribution in the stretched cellulose acylate film 12.

Cellulose acylate resins, cellulose acylate film processing methods etc., saturated norbornene resins, and saturated norbornene film processing methods etc. suitable for the present invention will now be described in order in more detail.

### (1) Plasticizer

The resin for producing the cellulose acylate film according to the present invention preferably comprises a polyhydric alcohol plasticizer. Such a plasticizer not only reduces the elastic modulus, but is also effective in reducing the difference in crystal level between the front side and the back side. The polyhydric alcohol plasticizer has a content of preferably 2 to 20 wt. % of the cellulose acylate. The polyhydric alcohol plasticizer has a content of preferably 2 to 20 wt. % of the cellulose acylate, more preferably 3 to 18 wt. %, and even more preferably 4 to 15 wt. %.

If the polyhydric alcohol plasticizer content is less than 2 wt. %, the above-described effects cannot be sufficiently achieved. On the other hand, if the polyhydric alcohol plasticizer content is more than 20 wt. %, “bleeding” (precipitation of the plasticizer onto the surface) of the film occurs. Polyhydric alcohol plasticizers which can specifically be used in the present invention include glycerin ester compounds such as glycerin ester and diglycerin ester, polyalkylene glycols such as polyethylene glycol and polypropylene glycol, and compounds wherein an acyl group is bound to the hydroxyl group of polyalkylene glycol, which have a good compatibility with cellulose fatty acid ester and exhibit a remarkable thermoplastic effect.

Specific examples of the glycerin ester include glycerin diacetate stearate, glycerin diacetate palmitate, glycerin diacetate myristate, glycerin diacetate laurate, glycerin diacetate caprate, glycerin diacetate nonanate, glycerin diacetate octanoate, glycerin diacetate heptanoate, glycerin diacetate hexanoate, glycerin diacetate pentanoate, glycerin diacetate oleate, glycerin acetate dicaprate, glycerin acetate dinonanate, glycerin acetate dioctanoate, glycerin acetate diheptanoate, glycerin acetate dicaproate, glycerin acetate divalerate, glycerin acetate dibutyrate, glycerin dipropionate caprate, glycerin dipropionate laurate, glycerin dipropionate myristate, glycerin dipropionate palmitate, glycerin dipropionate stearate, glycerin dipropionate oleate, glycerin tributyrate, glycerin tripentanoate, glycerin monopalmitate, glycerin monostearate, glycerine distearate, glycerin propionate laurate and glycerin oleate propionate. However, these are not limitative and may be used independently or in combination thereof.

Of these, glycerin diacetate caprylate, glycerin diacetate pelargonate, glycerin diacetate caprate, glycerin diacetate laurate, glycerin diacetate myristate, glycerin diacetate palmitate, glycerin diacetate stearate and glycerin diacetate oleate are preferred.

Specific examples of the diglycerin esters include diglycerin tetraacetate, diglycerin tetrapropionate, diglycerin tetrabutyrate, diglycerin tetravalerate, diglycerin tetrahexanoate, diglycerin tetraheptanoate, diglycerin tetracaprylate, diglycerin tetrapelargonate, diglycerin tetracaprate, diglycerin tetralaurate, diglycerin tetramyristate, diglycerin tetrapalmitate, mixed acid esters of diglycerin such as diglycerintriacetate propionate, diglycerin triacetate butyrate, diglycerin triacetate valerate, diglycerin triacetate hexanoate, diglycerin triacetate heptanoate, diglycerin triacetate caprylate, diglycerin triacetate pelargonate, diglycerin triacetate caprate, diglycerin triacetate laurate, diglycerin triacetate myristate, diglycerin triacetate palmitate, diglycerin triacetate stearate, diglycerin triacetate oleate, diglycerin diacetate dipropionate, diglycerin diacetate dibutyrate, diglycerin diacetate divalerate, diglycerin diacetate dihexanoate, diglycerin diacetate diheptanoate, diglycerin diacetate dicaprylate, diglycerin diacetate dipelargonate, diglycerin diacetate dicaprate, diglycerin diacetate dilaurate, diglycerin diacetate dimyristate, diglycerin diacetate dipalmitate, diglycerin diacetate distearate, diglycerin diacetate dioleate, diglycerin-acetate tripropionate, diglycerin acetate tributyrate, diglycerin acetate trivalerate, diglycerin acetate trihexanoate, diglycerin acetate triheptanoate, diglycerin acetate tricaprate, diglycerin acetate tripelargonate, diglycerin acetate tricaprate, diglycerin acetate trilaurate, diglycerin acetate trimyristate, diglycerin acetate tripalmitate, diglycerin acetate tristearate and diglycerin acetate trioleate, diglycerin laurate, diglycerin stearate, diglycerin caprylate, diglycerin myristate and diglycerin oleate. However, these are not limitative, and may be used independently or in combination thereof.

Of these, diglycerin tetraacetate, diglycerin tetrapropionate, diglycerin tetrabutyrate, diglycerin tetracaprylate and diglycerin tetralaurate are preferred.

Specific examples of the polyalkylene glycols include, hut are not limited to, polyethylene glycol and polypropylene glycol having an average molecular weight of from 200 to 1,000, which may be used independently or in combination thereof.

Specific examples of the compounds wherein an acyl group is bound to the hydroxyl group of polyalkylene glycol include polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanate, polyoxyethylene caprate, polyoxyethylene laurate, polyoxyethylene myristate, polyoxyethylene palmitate, polyoxyethylene stearate, polyoxyethylene oleate, polyoxyethylene linoleate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanate, polyoxypropylene caprate, polyoxypropylene laurate, polyoxypropylene myristate, polyoxypropylene palmitate, polyoxypropylene stearate, polyoxypropylene oleate and polyoxypropylene linoleate which, however, are not limitative and may be used independently or in combination thereof.

For such polyhydric alcohols to be fully effective, cellulose acylate is preferably formed into a film by melting under the following conditions. Specifically, while mixed pellets of cellulose acylate and polyhydric alcohol are melted in an extruder and extruded through a T die to form a film, the extruder outlet temperature (T2) is preferably higher than the extruder entrance temperature (T1), and the die temperature (T3) is preferably higher than (T2). More specifically, temperature is preferably increased as the melting proceeds. This is because of the following reasons: when the temperature is high even at the entrance, polyhydric alcohol is first dissolved and liquefied; since cellulose acylate floats in the liquid, it cannot receive sufficient shear force from the screw, and therefore undissolved matters are generated; such a composition which is not mixed sufficiently cannot exhibit the above advantage of the plasticizer, failing to give an effect of suppressing the difference on both sides of the melted film after melt extrusion. Moreover, such undissolved matter forms fish eye-type defects after film forming. Such defects do not form a bright point even if observed with a polarizing plate, but are rather visible when observed on a screen by projecting light from the backside of the film. In addition, fish eyes result in tailing at the die outlet and increased die lines.

T1 is preferably 150 to 200° C., more preferably 160 to 195° C., and even more preferably 165 or more to 190° C. or less. T2 is preferably in the range of 190 to 240° C., more preferably 200 to 230° C., and even more preferably 200 to 225° C. It is important that the melt temperature of such T1 and T2 are not higher than 240° C. If this temperature is exceeded, the formed film tends to have a higher elastic modulus. This seems to be because since melting is performed at a high temperature, cellulose acylate is decomposed and crosslinking is induced to increase the elastic modulus. The die temperature T3 is preferably 200 to less than 235° C., more preferably 205 to 230° C., and even more preferably 205° C. or more to 225° C. or less.

### (2) Stabilizer

In the present invention, either or both of a phosphite compound and a phosphorus acid ester compound is preferably used as a stabilizer. This suppresses deterioration over time and improves the problem of die lines. This is because such compounds serve as a leveling agent and removes die lines formed due to irregularities of the die.

Such a stabilizer is added in an amount of preferably 0.005 to 0.5 wt. %, more preferably 0.01 to 0.4 wt. %, and even more preferably 0.02 to 0.3% wt. %.

### (i) Phosphite Stabilizer

Although phosphite anti-coloring agents are not specifically limited, phosphite anti-coloring agents represented by the chemical formulae (1) to (3) are preferred.

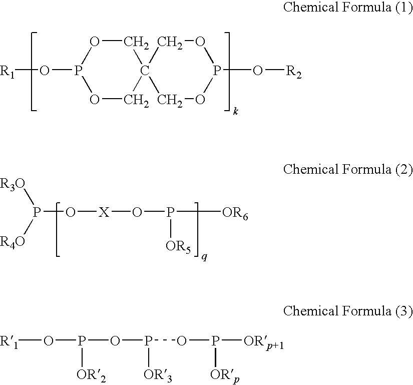

(wherein R1, R2, R3, R4, R5, R6, R′1, R′2, R′3 . . . R′n and R′n+1 represent hydrogen or a group selected from the group consisting of alkyl, aryl, alkoxyalkyl, aryloxyalkyl, alkoxyaryl, arylalkyl, alkylaryl, polyaryloxyalkyl, polyalkoxyalkyl and polyalkoxyaryl having carbon number from 4 to 23; provided that they are not simultaneously hydrogen in the respective formulae of chemical formulae (1), (2), and (3). X in the phosphite anti-coloring agent represented by the chemical formula (2) represents a group selected from the group consisting of aliphatic chains, aliphatic chains containing an aromatic nucleus in a side chain, aliphatic chains containing an aromatic nucleus in a chain and chains containing two or more non-adjacent oxygen atoms in the above chain; and k and q represent an integer of 1 or more, and p represents an integer of 3 or more)).

k and q in these phosphite anti-coloring agents are preferably an integer of 1 to 10. k and q are preferably an integer of 1 or more, because volatility upon heating is low, and k and q are preferably an integer of 10 or less, because compatibility with cellulose acetate propionate is improved. p is preferably an integer of 3 to 10. p is preferably an integer of 3 or more, because volatility upon heating is low, and p is preferably an integer of 10 or less, because compatibility with cellulose acetate propionate is improved.

Preferred specific examples of phosphite anti-coloring agents represented by the following chemical formula (1) include those represented by the following formulae (4) to (7).

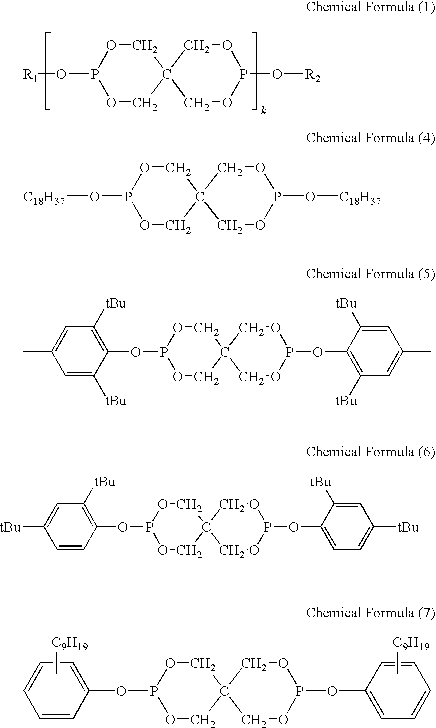

Preferred specific examples of phosphite anti-coloring agents represented by the following chemical formula (2) include those represented by the following formulae (8), (9) and (10).

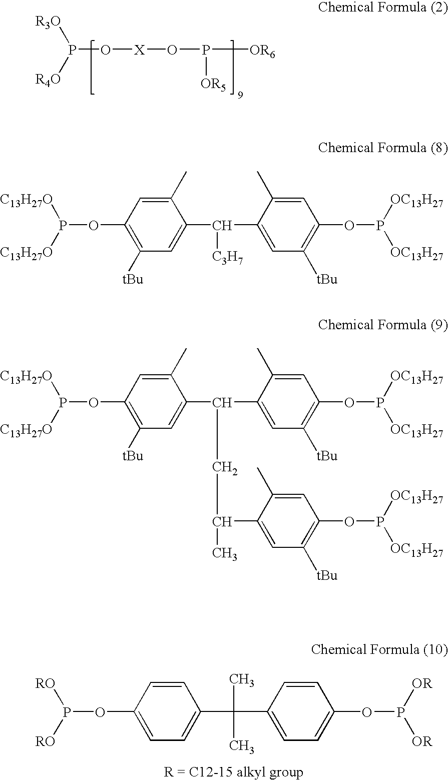

### (ii) Phosphorus Acid Ester Stabilizer

Examples of phosphorus acid ester stabilizers include cyclic neopentanetetrayl bis(octadecyl)phosphite, cyclic neopentanetetrayl bis(2,4-di-t-butylphenyl)phosphite, cyclic neopentanetetrayl bis(2,6-di-t-butyl-4-methylphenyl)phosphite, 2,2-methylenebis(4,6-di-t-butylphenyl)octyl phosphite and tris(2,4-di-t-butylphenyl)phosphite.

(iii) Other Stabilizers

Weak organic acids, thioether compounds, epoxy compounds or the like may also be added as a stabilizer.

“Weak organic acid” means an organic acid whose pKa is 1 or higher. The weak organic acid is not particularly limited as long as it does not inhibit the action of the present invention and has anti-coloring properties and anti-degradation properties. Examples of weak organic acids include tartaric acid, citric acid, malic acid, fumaric acid, oxalic acid, succinic acid and maleic acid. These may be used singly or in combination of two or more.

Examples of thioether compounds include dilauryl thiodipropionate, ditridecyl thiodipropionate, dimyristyl thiodipropionate, distearyl thiodipropionate and palmityl stearyl thiodipropionate. These may be used singly or in combination of two or more.

Examples of epoxy compounds include those derived from epichlorohydrin and bisphenol A. Derivatives from epichlorohydrin and glycerin, and cyclic compounds such as vinyl cyclohexene dioxide and 3,4-epoxy-6-methylcyclohexylmethyl-3,4-epoxy-6-methylcyclohexane carboxylate may also be used. In addition, epoxidized soybean oil, epoxidized castor oil and long chain α-olefin oxide may also be used. These may be used singly or in combination of two or more.

### (3) Cellulose Acylate

### <<Cellulose Acylate Resin>>

### (Composition, Degree of Substitution)

Preferably, the cellulose acylate used in the present invention satisfies all of the requirements represented by the following equations (1) to (3):

2.0≦X+Y≦3.0 Equation (1)

0≦X≦2.0 Equation (2)

1.2≦Y≦2.9 Equation (3)

(in the equations (1) to (3), X represents the degree of substitution by an acetate group and Y represents the total degree of substitution by a propionate group, a butyrate group, a pentanoyl group and a hexanoyl group)

More preferably,

2.4≦X+Y≦3.0 Equation (4)

0.05≦X≦1.8 Equation (5)

1.3≦Y≦2.9 Equation (6)

Even more preferably,

2.5≦X+Y≦2.95 Equation (7)

0.1≦X≦1.6 Equation (8)

1.4≦Y≦2.9 Equation (9)

As described above, a characteristic of the present invention is to introduce a propionate group, a butyrate group, a pentanoyl group and a hexanoyl group into cellulose acylate. The above ranges are preferred because the melting temperature can be lowered and thermal decomposition upon melt film forming can be suppressed. On the other hand, beyond these ranges and elasticity goes beyond the range of the present invention, which is not preferable.

The cellulose acylate may be used singly or in combination of two or more. In addition, a polymer component other than cellulose acylate may also be appropriately added.

The process for producing the cellulose acylate of the present invention will now be described in detail. Raw cotton for producing cellulose acylate in the present invention and the method of synthesis of the cellulose acylate are also disclosed in detail at pages 7 to 12 of Journal of Technical Disclosure (Kokai Giho) (Kogi No. 2001-1745, published on Mar. 15, 2001, by Japan Institute of Invention and Innovation).

### (Raw Material and Pretreatment)

As raw materials for cellulose, those derived from hardwood pulp, softwood pulp or cotton linter are preferably used. Raw materials for cellulose having a high purity whose α-cellulose content is 92% by mass or more to 99.9% by mass or less are preferably used.

When the raw materials for the cellulose are in film or bulk form, the materials are preferably previously crushed. Crushing is preferably continued until the cellulose is turned into a fluff.

### (Activation)

It is preferred to subject the cellulose raw material to a treatment (activation) of contacting with an activating agent prior to acylation. As the activating agent, a carboxylic acid or water can be used. However, if water is used, it is preferred to include a step of dewatering by adding a carboxylic acid in excess after the activation, washing with a carboxylic acid to substitute the water, or regulating the acylation conditions. The activation agent may be added by regulating to any temperature. As the adding method, a suitable method can be selected from among, for example, spraying, dropwise addition, and dipping.

Carboxylic acids preferred as the activating agents are carboxylic acids having carbon number from 2 to 7 (e.g., acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentanecarboxylic acid, heptanoic acid, cyclohexanecarboxylic acid and benzoic acid). More preferred are acetic acid, propionic acid and butyric acid, and particularly preferred is acetic acid.

In activation, a catalyst for acylation such as sulfuric acid may optionally be added. However, when a strong acid such as sulfuric acid is added, depolymerization may be promoted, and thus the addition amount thereof is preferably limited to about 0.1% by mass to 10% by mass based on the cellulose. Further, two or more kinds of activating agents may be used in combination or an acid anhydride of a carboxylic acid having carbon number of 2 or more to 7 or less may also be added.

The addition amount of the activating agent is preferably 5% by mass or more, more preferably 10% by mass or more, and particularly preferably 30% by mass or more, based on the cellulose. The amount of the activating agent is preferably equal to or more than this lower limit value because problems such as a reduction in the level of cellulose activation are prevented. As to the upper limit of the addition amount of the activating agent, there is no particular limit as long as productivity is not reduced. However, the addition amount is preferably not more than a 100-fold amount by mass, more preferably not more than a 20-fold amount by mass, and particularly preferably not more than a 10-fold amount by mass, based on the cellulose. The activation may be carried out by adding a large excess of the activating agent with respect to cellulose, and then reducing the amount of the activating agent by carrying out an operation such as filtering, blow drying, heat drying, vacuum distillation, solvent substitution and the like.

The activation time is preferably 20 minutes or longer. As to the upper limit, there is no particular limit as long as no detrimental influences are exerted on productivity, although the activation time is preferably 72 hours or shorter, more preferably 24 hours or shorter, and particularly preferably 12 hours or shorter. Also, the activation temperature is preferably from 0° C. or more to 90° C. or less, more preferably from 15° C. or more to 80° C. or less, and particularly preferably from 20° C. or more to 60° C. or less. The cellulose activation step may be carried out under increased pressure or under reduced pressure. Further, as the heating means, electromagnetic waves such as microwaves and infrared waves may be used.

### (Acylation)

In the process for producing cellulose acylate in the present invention, it is preferred to acylate the hydroxyl groups of the cellulose by adding a carboxylic acid anhydride to the cellulose and reacting the resultant mixture in the presence of a Bronsted acid or Lewis acid as a catalyst.

Examples of the process for obtaining the cellulose mixed acylate include a process of reacting as the acylating agent two kinds of carboxylic anhydrides by using a mixture thereof or by successively adding them, a process of using a mixed acid anhydride prepared from two kinds of carboxylic acids (e.g., acetic-propionic mixed acid anhydride), a process of synthesizing a mixed acid anhydride (e.g., acetic-propionic mixed acid anhydride) within the reaction system using a carboxylic acid and an acid anhydride of another carboxylic acid (e.g., acetic and propionic anhydride) and reacting the mixed acid anhydride with cellulose, and a process of once synthesizing a cellulose acylate having a degree of substitution of less than 3 and further acylating remaining hydroxyl groups with an acid anhydride or an acid halide.

### (Acid Anhydride)

The carboxylic anhydride preferably has carbon number of 2 or more to 7 or less in the carboxylic acid moiety. Examples thereof include acetic anhydride, propionic anhydride, butyric anhydride, 2-methylpropionic anhydride, valeric anhydride, 3-methylbutyric anhydride, 2-methylbutyric anhydride, 2,2-dimethylpropionic anhydride (pivalic anhydride), hexanoic anhydride, 2-methylvaleric anhydride, 3-methylvaleric anhydride, 4-methylvaleric anhydride, 2,2-dimethylbutyric anhydride, 2,3-dimethylbutyric anhydride, 3,3-dimethylbutyric anhydride, cyclopentanecarboxylic anhydride, heptanoic anhydride, cyclohexanecarboxylic anhydride, benzoic anhydride and the like. Preferred are acetic anhydride, propionic anhydride, butyric anhydride, valeric anhydride, hexanoic anhydride, and heptanoic anhydride, and particularly preferred are acetic anhydride, propionic anhydride, and butyric anhydride.

For the purpose of producing a mixed ester, it is preferable to use these acid anhydrides in combination. The mixing ratio is preferably determined according to the rate of substitution of the target mixed ester. The acid anhydride is usually added in an equivalent excess with respect to the cellulose. Specifically, the acid anhydride is added in an amount of preferably from 1.2 to 50 equivalents, more preferably from 1.5 to 30 equivalents, and particularly preferably from 2 to 10 equivalents, with respect to the hydroxyl group of cellulose.

### (Catalyst)

As the catalyst for acylation in the present invention used in the production of the cellulose acylate, a Bronsted acid or a Lewis acid is preferably used. Definition of the Bronsted acid and the Lewis acid is described in, for example, Dictionary of Physical Sciences (Rikagaku Jiten), fifth edition (2000). Preferred examples of the Bronsted acid include sulfuric acid, perchloric acid, phosphoric acid, methanesulfonic acid, benzenesulfonic acid, p-toluenesulfonic acid and the like. Preferred examples of the Lewis acid include zinc chloride, tin chloride, antimony chloride, magnesium chloride and the like.

Preferred examples of the catalyst include sulfuric acid and perchloric acid, and sulfuric acid is particularly preferred. The preferred addition amount of the catalyst is from 0.1 to 30% by mass, more preferably from 1 to 15% by mass, and particularly preferably from 3 to 12% by mass, based on the cellulose.

### (Solvent)

When conducting acylation, a solvent may be added to adjust viscosity, the reaction rate, stirring properties and acyl substitution ratio. Examples of solvents which may be used include dichloromethane, chloroform, carboxylic acid, acetone, ethyl methyl ketone, toluene, dimethylsulfoxide, sulfolane or the like. However, a carboxylic acid is preferably used. Examples of such a carboxylic acid include carboxylic acids having carbon number of 2 or more to 7 or less (e.g., acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentanecarboxylic acid) and the like. More preferred are acetic acid, propionic acid, butyric acid and the like. These solvents may be used in mixtures.

### (Conditions for Acylation)

When conducting acylation, the acid anhydride and the catalyst and, optionally, the solvent may be mixed with each other, followed by mixing the resulting mixture with cellulose or, alternatively, these may separately and successively be mixed with cellulose. However, it is usually preferred that a mixture of the acid anhydride and the catalyst or a mixture of the acid anhydride, the catalyst and the solvent is prepared as an acylating agent before reaction with cellulose. In order to suppress an increase in temperature inside the reactor due to heat of acylation reaction, it is preferred to previously cool the acylating agent. The cooling temperature is preferably −50° C. to 20° C., more preferably −35° C. to 10° C., and particularly preferably −25° C. to 5° C. The acylating agent may be added in a liquid state, or in a solid state by freezing the agent into a crystal, flake or block form.

Further, the acylating agent may be added to cellulose all at once or in portions. Also, the cellulose may be added to the acylating agent all at once or in portions. In the case of adding the acylating agent in portions, an acylating agent having an identical composition may be used, or a plurality of acylating agents having different compositions may be used. Preferred examples include: 1) first, adding a mixture of the acid anhydride and the solvent, and then adding the catalyst; 2) first, adding a mixture of the acid anhydride, portion of and a part of the solvent and the catalyst, then adding a mixture of the rest of the catalyst and the solvent; 3) first, adding a mixture of the acid anhydride and the solvent, and then adding a mixture of the catalyst and the solvent; and 4) first, adding the solvent, and then adding a mixture of the acid anhydride and the catalyst or a mixture of the acid anhydride, the catalyst, and the solvent.

Although the acylation of cellulose is an exothermic reaction, in the process for producing the cellulose acylate according to the present invention, the highest temperature reached during acylation is preferably not greater than 50° C. When the reaction temperature is equal to or less than this temperature, there does not arise the problem of the depolymerization proceeding so much that production of a cellulose acylate having a polymerization degree suited for the use of the invention becomes difficult. Thus, such temperature range is preferred. The highest temperature reached in the acylation is more preferably not greater than 45° C., more preferably not greater than 40° C. and particularly preferably not greater than 35° C. The reaction temperature may be controlled using a temperature regulating apparatus, or by the initial temperature of the acylating agent. The reaction temperature may also be controlled using the vaporization heat of the liquid components in the reaction system by reducing the pressure of the reactor. Since the generated heat during acylation is larger during the initial stages of the reaction, the reaction temperature may also be controlled by cooling during the initial stages of the reaction, and heating thereafter. The finishing point of acylation can be determined by means such as light transmittance, solution viscosity, temperature change of the reaction system, solubility of the reactants in the organic solvent, observation with a polarizing microscope and the like.

The lowest temperature of the reaction is preferably not lower than −50° C., more preferably not lower than −30° C., and particularly preferably not lower than −20° C. The acylation time is preferably 0.5 hours or more to 24 hours or less, more preferably 1 hour or more to 12 hours or less, and particularly preferably 1.5 hours or more to 6 hours or less. If the acylation time is 0.5 hours or less, the reaction does not sufficiently proceed under normal reaction conditions, while an acylation time of more than 24 hours is not preferred for industrial production.

### (Quenching Agent)

In the process for producing the cellulose acylate to be used in the present invention, it is preferred to add a quenching agent after the acylation reaction.

The quenching agent may be any substance capable of decomposing an acid anhydride. Preferred examples thereof include water, alcohol (e.g., ethanol, methanol, propanol, isopropyl alcohol, etc.) or compositions containing these, and the like. Further, the quenching agent may contain a neutralizing agent which is described below. During the addition of the quenching agent, a large amount of generated heat surpassing the cooling capacity of the reactor may be generated, possibly causing a decrease in the polymerization degree of the cellulose acylate, precipitation of cellulose acylate in an undesired form and or the like. To avoid such problems, it is preferable to add a mixture of water and a carboxylic acid such as acetic acid, propionic acid, butyric acid or the like, rather than to directly add water or alcohol. Acetic acid is particularly preferable as the carboxylic acid. The composition ratio of the carboxylic acid and water may be an arbitrary ratio, but it is preferable to have the content of water in the range of 5% by mass to 80% by mass, more preferably 10% by mass to 60% by mass and particularly preferably 15% by mass to 50% by mass.

The quenching agent may be added to the acylation reactor, or the reactants may be added to the vessel of the quenching agent. The quenching agent is preferably added over a time period of 3 minutes to 3 hours. The addition time of the quenching agent is preferably 3 minutes or more because problems such as causing a reduction in the polymerization degree due to the generated heat being too large, insufficient hydrolysis of the acid anhydride, reduced stability of the cellulose acylate and the like can be avoided. The addition time of the quenching agent is preferably not greater than 3 hours because problems such as deterioration in the industrial productivity and the like can be avoided. The addition time of the quenching agent is preferably 4 minutes or more to 2 hours or less, more preferably 5 minutes or more to 1 hour or less, and especially preferably 10 minutes or more to 45 minutes or less. During addition of the quenching agent, the reactor may be cooled or not cooled, but to suppress depolymerization, it is preferable to suppress temperature increase by cooling the reactor. It is also preferable to have the quenching agent preliminarily cooled.

### (Neutralizing Agent)

During the acylation reaction quenching step or after the acylation reaction quenching step, a neutralizing agent (e.g., carbonates, acetates, hydroxides, or oxides of calcium, magnesium, iron, aluminum or zinc) or a solution thereof may be added for the purpose of hydrolysis of excessive carboxylic acid anhydride remaining in the system and neutralization of part or all of the carboxylic acid and esterification catalyst. Preferred examples of the solvent for the neutralizing agent include water, alcohols (e.g., ethanol, methanol, propanol, isopropyl alcohol, etc.), carboxylic acids (e.g., acetic acid, propionic acid, butyric acid, etc.), ketones (e.g., acetone, ethyl methyl ketone, etc.), polar solvents such as dimethylsulphoxide and a mixed solvent thereof.

### (Partial Hydrolysis)

The thus-obtained cellulose acylate has a total degree of substitution of nearly 3 and, for the purpose of obtaining cellulose acylate having a desired degree of substitution, it is generally conducted to maintain the obtained cellulose acylate at 20 to 90° C. for several minutes to several days in the presence of a small amount of a catalyst (generally, residual acylating catalyst such as sulfuric acid) and water to thereby partially hydrolyze the ester bond and reduce the acyl degree of substitution of the cellulose acylate to a desired level (so-called ripening). The amount of the sulfuric acid ester bound to the cellulose can be reduced in the process of partial hydrolysis by also allowing hydrolysis of the sulfuric acid ester of the cellulose, and by adjusting the conditions for hydrolysis.

It is preferable to terminate the partial hydrolysis at the point where the desired cellulose acylate is obtained by completely neutralizing the catalyst remaining in the system using a neutralizing agent or a solution thereof as described above. It is also preferable to effectively remove the catalyst (e.g., sulfuric acid ester) in the solution or bound to the cellulose by adding a neutralizing agent which produces a salt of low solubility in the reaction solution (e.g., magnesium carbonate, magnesium acetate, etc.).

### (Filtration)

For the purpose of removing or reducing unreacted materials, slightly soluble salts and other foreign matters in the resultant cellulose acylate, it is preferred to conduct filtration of the reaction mixture (dope). The filtration may be conducted at any step between completion of acylation and re-precipitation. It is also preferred to dilute with a suitable solvent prior to filtration for the purpose of controlling filtration pressure and handling properties.

### (Re-Precipitation)

Cellulose acylate can be re-precipitated from the thus-obtained cellulose acylate solution by mixing the cellulose acylate solution into a poor solvent such as water or an aqueous solution of a carboxylic acid (e.g., acetic acid or propionic acid) or by mixing a poor solvent into the cellulose acylate solution, followed by washing and a stabilizing treatment to obtain an intended cellulose acylate. The re-precipitation may be conducted continuously or batchwise with each batch treating a definite amount. It is also preferable to control the form or molecular weight distribution of the re-precipitated cellulose acylate by adjusting the concentration of the cellulose acylate solution and the composition of the poor solvent by means of the mode of substitution or polymerization degree of the cellulose acylate.

### (Washing)

The resultant cellulose acylate is preferably subjected to a washing treatment. As a washing solvent, any solvent may be used that scarcely dissolves cellulose acylate and can remove impurities. Usually, however, water or warm water is used. The temperature of the washing water is preferably 25° C. to 100° C., more preferably 30° C. to 90° C., and particularly preferably 40° C. to 80° C. The washing treatment may be carried out in a so-called batch mode where alternation of filtration and washing liquid is repeated, or may be carried out using a continuous washing apparatus. It is preferable to reuse the waste water generated in the re-precipitation and washing processes as the poor solvent for the re-precipitation process, or to recover the solvent such as carboxylic acid by means of distillation or the like and reuse the solvent.

The course of the washing may be traced by any means, but preferred examples include methods involving hydrogen ion concentration, ion chromatography, electric conductivity, ICP, elemental analysis, atomic absorption spectrum and the like.

Such treatment allows removal of the catalyst (sulfuric acid, perchloric acid, trifluoroacetic acid, p-toluenesulfonic acid, methanesulfonic acid, zinc chloride, etc.), neutralizing agent (e.g., carbonate, acetate, hydroxide, or oxide of calcium, magnesium, iron, aluminum or zinc, etc.), reaction product between the neutralizing agent and the catalyst, carboxylic acid (acetic acid, propionic acid, butyric acid, etc.), reaction product between the neutralizing agent and carboxylic acid, and the like, and thus is effective in enhancing the stability of the cellulose acylate.

### (Stabilization)

To further improve stability or reduce the odor of the carboxylic acid, the cellulose acylate washed with warm water is preferably treated with an aqueous solution of a weak alkali (such as carbonates, hydrogencarbonates, hydroxides and oxides of sodium, potassium, calcium, magnesium and aluminum).

The amount of residual impurities can be controlled by the amount of the washing liquid, the washing temperature, time, stirring method, the form of the washing vessel, or the composition or concentration of the stabilizer. In the present invention, the conditions for the acylation, partial hydrolysis, neutralization and washing are set such that the amount of residual sulfate radicals (in terms of the content of sulfur atoms) is 0 to 500 ppm.

### (Drying)

In the present invention, to adjust the water content in the cellulose acylate to a preferred amount, it is preferred to dry the cellulose acylate. The drying method is not especially limited, as long as the desired water content can be obtained. However, it is preferable to carry out the drying efficiently by using means such as heating, blow drying, pressure reduction, stirring and the like individually or in combination. The drying temperature is preferably 0 to 200° C., more preferably 40 to 180° C., and especially preferably 50 to 160° C. The cellulose acylate according to the present invention has a water content of preferably 2% by mass or less, more preferably 1% by mass or less, and especially preferably 0.7% by mass or less.

### (Shape)

The cellulose acylate of the present invention can take various forms such as particles, powders, fibers or masses. However, as a raw material for producing a film, a particulate form or a powdery form is preferred. Therefore, the dried cellulose acylate may be pulverized or sieved in order to unify the particle size or improve handling properties. When the cellulose acylate is in a particulate form, 90% by mass or more of the particles to be used should have a particle size of preferably from 0.5 to 5 mm, and 50% by mass or more of the particles to be used should have a particle size of preferably from 1 to 4 mm. The cellulose acylate particles preferably have a shape as spherical as possible. Also, the cellulose acylate particles of the present invention have an apparent density of preferably from 0.5 to 1.3, more preferably from 0.7 to 1.2, and especially preferably from 0.8 to 1.15. The method for measuring the apparent density is specified in JIS K-7365.

The cellulose acylate particles of the present invention have an angle of repose of preferably from 10 to 70 degrees, more preferably from 15 to 60 degrees, and particularly preferably from 20 to 50 degrees.

### (Polymerization Degree)

The cellulose acylate to be used in the present invention has an average polymerization degree of preferably from 100 to 300, more preferably from 120 to 250, and particularly preferably from 130 to 200. The average polymerization degree can be measured according to, for example, the limiting viscosity method of Uda et al. (Kazuo Uda & Hideo Saito; Journal of the Society of Fiber Science and Technology, Japan (Sen-Gakkai Shi), vol. 18, No. 1, pp. 105-120, 1962) or the molecular weight distribution-measuring method by gel permeation chromatography (GPC). The average polymerization degree is also described in detail in Japanese Patent Application Laid-Open No. 9-95538.

In the present invention, the weight average polymerization degree/number average polymerization degree based on the GPC results for cellulose acylate is preferably 1.6 to 3.6, more preferably 1.7 to 3.3, and particularly preferably 1.8 to 3.2.

The cellulose acylate may be used singly or in combination of two or more. In addition, a polymer component other than cellulose acylate may also be appropriately added. The mixed polymer component preferably has excellent compatibility with cellulose acylate, and has a transmittance when formed into a film of preferably 80% or more, more preferably 90% or more, and especially preferably 92% or more.

### (Synthesis Example of Cellulose Acylate)

A synthesis example of the cellulose acylate used in the present invention will now be described in more detail, but the present invention is not limited thereto.

### Synthesis Example 1

### Synthesis of Cellulose Acetate Propionate

A 5 L separable flask serving as the reactor which was equipped with a reflux apparatus was charged with 150 g of cellulose (hardwood pulp) and 75 g of acetic acid. The resultant mixture was vigorously stirred for 2 hours while heating with an oil bath having a temperature regulated to 60° C. The thus-pretreated cellulose was swollen and ground to form a fluff. The reactor was cooled by being left to stand for 30 minutes in a 2° C. ice bath.

Separately, a mixture of 1545 g of propionic anhydride and 10.5 g of sulfuric acid was prepared as an acylating agent and cooled to −30° C. The mixture was then added all at once to a reactor containing the above pretreated cellulose. After 30 minutes, the temperature of the outer equipment was gradually increased, so that the internal temperature was regulated to 25° C. two hours after the addition of the acylating agent. The reactor was cooled in a 5° C. ice bath, so that the internal temperature was regulated to 10° C. 0.5 hours after the addition of the acylating agent and 23° C. two hours after the addition of the acylating agent. The mixture was stirred for a further 3 hours while keeping the internal temperature at 23° C. The reactor was cooled in a 5° C. ice bath, and then 120 g of 25% by mass aqueous acetic acid cooled to 5° C. was charged into the reactor over one hour. The internal temperature was increased to 40° C., and the mixture was stirred for 1.5 hours. Next, a solution, in which two-fold molar excess of magnesium acetate tetrahydrate with respect to sulfuric acid was dissolved in 50% by mass aqueous acetic acid, was charged into the reactor, and the resultant mixture was stirred for 30 minutes. The mixture was then charged with 1 L of 25% by mass aqueous acetic acid, 500 mL of 33% by mass aqueous acetic acid, 1 L of 50% by mass aqueous acetic acid, and 1 L of water in that order to cause cellulose acetate propionate to precipitate. The obtained cellulose acetate propionate precipitate was washed with warm water. By varying the washing conditions at this stage, cellulose acetate propionate having a variable amount of residual sulfate radicals was obtained. After washing, the obtained cellulose acetate propionate precipitate was stirred for 0.5 hours in 20° C., 0.005% by mass aqueous calcium hydroxide solution, further washed with water until the pH of the washing liquid was 7, and then dried under vacuum at 70° C.

According to ¹H-NMR and GPC measurements, the obtained cellulose acetate propionate had an acetylation degree of 0.30, a propionylation degree of 2.63, and a polymerization degree of 320. The content of sulfate radicals was measured by ASTM D-817-96.

### Synthesis Example 2

### Synthesis of Cellulose Acetate Butyrate

A 5 L separable flask serving as the reactor which was equipped with a reflux apparatus was charged with 100 g of cellulose (hardwood pulp) and 135 g of acetic acid. The resultant mixture was left to stand for one hour while heating with an oil bath having a temperature regulated to 60° C. The mixture was then vigorously stirred for one hour while heating with the oil bath having a temperature regulated to 60° C. The thus-pretreated cellulose was swollen and ground to form a fluff. The reactor is cooled by being left to stand for one hour in a 5° C. ice bath to thoroughly cool the cellulose.

Separately, a mixture of 1080 g of butyric anhydride and 10.0 g of sulfuric acid was prepared as an acylating agent and cooled to −20° C. The mixture was then added all at once to a reactor containing the above pretreated cellulose. After 30 minutes, the temperature of the outer equipment was increased to 20° C., and the mixture was allowed to react for 5 hours. The reactor was cooled in a 5° C. ice bath, and then 2400 g of 12.5% by mass aqueous acetic acid cooled to about 5° C. was charged into the reactor over one hour. The internal temperature was increased to 30° C., and the mixture was stirred for one hour. Next, 100 g of a 50% by mass aqueous solution of magnesium acetate tetrahydrate was charged into the reactor, and the resultant mixture was stirred for 30 minutes. The mixture was then gradually charged with 1000 g of acetic acid and 2500 g of 50% by mass aqueous acetic acid to cause cellulose acetate butyrate to precipitate. The obtained cellulose acetate butyrate precipitate was washed with warm water. By varying the washing conditions at this stage, cellulose acetate butyrate having a variable amount of residual sulfate radicals was obtained. After washing, the obtained cellulose acetate butyrate precipitate was stirred for 0.5 hours in 0.005% by mass aqueous calcium hydroxide solution, further washed with water until the pH of the washing liquid was 7, and then dried at 70° C. The obtained cellulose acetate butyrate had an acetylation degree of 0.84, a butyration degree of 2.12, and a polymerization degree of 268.

### (4) Other Additives

### (i) Matting Agent

Preferably, fine particles are added as a matting agent. Examples of fine particles used in the present invention include silicon dioxide, titanium dioxide, aluminum oxide, zirconium oxide, calcium carbonate, calcium carbonate, talc, clay, calcined kaolin, calcined calcium silicate, hydrated calcium silicate, aluminum silicate, magnesium silicate and calcium phosphate. Fine particles containing silicon are preferred because turbidity can be decreased, and silicon dioxide is particularly preferred. Fine particles of silicon dioxide having a primary average particle size of 20 nm or less and an apparent specific gravity of 70 g/liter or more are preferred. Those having an average particle size of primary particles of as small as 5 to 16 nm are particularly preferred because the haze of the film can be decreased. The apparent specific gravity is preferably 90 to 200 g/liter or more, and more preferably 100 to 200 g/liter or more. A greater apparent specific gravity is preferred because a dispersion having a higher concentration can be prepared, the haze is improved and agglomerates are decreased.

These fine particles generally form secondary particles having an average particle size of 0.1 to 3.0 μm. These fine particles are present as an agglomerate of primary particles in the film, creating irregularities of 0.1 to 3.0 μm on the surface of the film. The average particle size of secondary particles is preferably 0.2 μm or more to 1.5 μm or less, more preferably 0.4 μm or more to 1.2 μm or less, and most preferably 0.6 μm or more to 1.1 μm or less. For determining the primary and secondary particle sizes, particles in the film are observed by a scanning electron microscope and the diameter of a circle circumscribing the particle is defined as the particle size. Further, 200 particles are observed at a different position, and the average value of the particle size was defined as the average particle size.

For fine particles of silicon dioxide, for example, commercially available products such as Aerosil R972, R972V, R974, R812, 200, 200V, 300, R202, OX50, and TT600 (available from Nippon Aerosil Co., Ltd.) can be used. Fine particles of zirconium oxide sold, for example, under the trade name Aerosil R976 and R811 (available from Nippon Aerosil Co., Ltd.) can be used.

Of these, Aerosil 200V and Aerosil R972V are fine particles of silicon dioxide having a primary average particle size of 20 nm or less and an apparent specific gravity of 70 g/liter or more. These particles are particularly preferred because they have a significant effect of reducing the coefficient of friction while keeping low the turbidity of the optical film.

### (ii) Other Additives

In addition to the above, various additives, for example, ultraviolet protective agents (e.g., hydroxybenzophenone compounds, benzotriazole compounds, salicylic ester compounds, cyanoacrylate compounds), infrared absorbers, optical anisotropy controllers, surfactant and odor trapping agents (amines etc.) can be added. Materials whose details are described in Journal of Technical Disclosure (Kokai Giho) (Kogi No. 2001-1745, published on Mar. 15, 2001, by Japan Institute of Invention and Innovation, pp. 17 to 22 are preferably used.

An infrared absorbing dye described, for example, in Japanese Patent Application Laid-Open No. 2001-194522 may be used. An ultraviolet absorber described, for example, in Japanese Patent Application Laid-Open No. 2001-151901 may be used. Preferably, each is included in cellulose acylate in a proportion of 0.001 to 5% by mass.

Examples of optical anisotropy controllers include retardation adjusters. For example, those described in Japanese Patent Application Laid-Open Nos. 2001-166144, 2003-344655, 2003-248117 and 2003-66230 may be used. Such an optical anisotropy controller can control in-plane retardation (Re) and retardation (Rth) in the thickness direction. The optical anisotropy controller is added in a proportion of preferably 0 to 10% wt. %, more preferably 0 to 8% wt. %, and even more preferably 0 to 6% wt. %.

### (5) Cellulose Acylate Mixture Properties

Preferably, the above cellulose acylate mixture (a mixture of cellulose acylate, a plasticizer, a stabilizer and other additives) satisfies the following properties.

### (i) Weight Loss

The thermoplastic cellulose acylate propionate composition of the present invention has a heat loss ratio of 5% by weight or less at 220° C. Here, the term “heat loss ratio” means the heat loss ratio at 220° C. when a sample is heated from room temperature at a temperature increase rate of 10° C./minute under a nitrogen gas atmosphere. By preparing the above-described cellulose acylate mixture, the heat loss ratio can be 5% by weight or less. The heat loss ratio is more preferably 3% by weight or less, and even more preferably 1% by weight or less. By having such a heat loss ratio, defects generated during the film formation (bubble formation) can be suppressed.

### (ii) Melt Viscosity

The thermoplastic cellulose acylate propionate composition of the present invention has a melt viscosity at 220° C., 1 sec⁻¹ of preferably 100 to 1,000 Pa·sec, more preferably 200 to 800 Pa·sec, and even more preferably 300 to 700 Pa·sec. By adjusting to such a high melt viscosity, the film is not extended (stretched) by the tension at the die outlet, and therefore the increase in optical anisotropy (retardation) caused by stretched alignment can be prevented.

Such viscosities may be adjusted by any process, and are adjustable, for example, by the polymerization degree of cellulose acylate or the amount of additives such as a plasticizer.

### (6) Pelletization

The cellulose acylate and additives described above are preferably mixed and pelletized before melt film forming.

For pelletization, cellulose acylate and additives are preferably previously dried, but a vented extruder may also be used instead of performing drying. When performing drying, methods such as heating in a heating furnace at 90° C. for eight hours may be employed, but the method is not limited thereto. Pellets can be prepared by melting the cellulose acylate and additives described above using a twin-screw extruder at 150° C. or more to 250° C. or less, and solidifying and cutting the same extruded in a shape like noodles in water. Alternatively, pelletization may be performed by an underwater cutting method in which the material is cut while being extruded into water directly through a nozzle after melting in an extruder.

For an extruder, any known single-screw extruder, a non-intermeshing counter-rotating twin-screw extruder, an intermeshing counter-rotating twin-screw extruder and an intermeshing co-rotating twin-screw extruder from which sufficient melt-kneading can be obtained may be used.

A preferred size of the pellets is a cross sectional area of 1 mm² or more to 300 mm² or less and a length of 1 mm or more to 30 mm or less, more preferably a cross sectional area of 2 mm² or more to 100 mm² or less and a length of 1.5 mm or more to 10 mm or less.

When carrying out pelletization, the above-described additives can also be introduced from a raw material introduction port or a vent port provided along the extruder.

The revolution rate of the extruder is preferably 10 rpm or more to 1,000 rpm or less, more preferably 20 rpm or more to 700 rpm or less, and even more preferably 30 rpm or more to 500 rpm or less. When the rotational speed is lower than that, there are the disadvantages that the residence time is extended, the molecular weight is decreased due to thermal degradation, and yellowing tends to worsen. When the rotational speed is too high, molecules tend to be broken due to shearing, resulting in a decrease in molecular weight, and problems such as increased generation of cross-linked gel tend to arise.

In the pelletization, the residence time for extrusion is preferably 10 seconds or more to 30 minutes or less, more preferably 15 seconds or more to 10 minutes or less, and even more preferably 30 seconds or more to 3 minutes or less. If sufficient melting can be done, the shorter the residence time, the better, because degradation of resin and occurrence of yellowing can be suppressed.

### (7) Melt Film Forming

### (i) Drying

Materials pelletized by the above method are preferably used. Before melt film forming, moisture in the pellets is preferably reduced.

In the present invention, to bring the moisture content of cellulose acylate to an appropriate level, cellulose acylate is preferably dried. As to the drying method, drying is mostly performed using a dehumidification dryer, but drying methods are not particularly limited as long as the intended moisture content can be achieved (preferably, drying is effectively performed using heating, blowing, decompression or stirring singly or in combination. More preferably, the hopper dryer has a heat insulation structure). The drying temperature is preferably 0 to 200° C., more preferably 40 to 180° C., and particularly preferably 60 to 150° C. When the drying temperature is too low, there is a disadvantage that not only drying takes time, but also the moisture content does not reach the intended value or lower. On the other hand, when the drying temperature is too high, there is a disadvantage that resin is adhered and causes blocking. The amount of drying air is preferably 20 to 400 m³/hour, more preferably 50 to 300 m³/hour, and particularly preferably 100 to 250 m³/hour. When the amount of drying air is small, the drying efficiency is disadvantageously low. On the other hand, even if the amount of drying air is increased, increase in the drying effect is small when the amount is above a certain level, and this is uneconomical. The dewpoint of the drying air is preferably 0 to −60° C., more preferably −10 to −50° C., and particularly preferably −20 to −40° C. The drying time is required to be at least 15 minutes, is more preferably 1 hour or more, and particularly preferably 2 hours or more. Even if drying is performed over 50 hours, the effect of reducing the moisture content is small. Since thermal degradation of the resin becomes a concern, the drying time should not be longer than required. The moisture content of the cellulose acylate in the present invention is preferably 1.0% by mass or less, more preferably 0.1% by mass or less, particularly preferably 0.01% by mass or less.

### (ii) Melt Extrusion

The above cellulose acylate resin is fed to a cylinder via a feed port of an extruder (different from the extruder used for the above pelletization). The cylinder interior is configured so that, in order from the feed port side, a feed section which conveys a fixed amount of cellulose acylate resin fed from the feed port (region designated by A), a compression section which melt-kneads and compresses the cellulose acylate resin (region designated by B), and a conveyance and metering section which meters the discharged amount of melt-kneaded and compressed cellulose acylate resin (region designated by C). The resin is preferably dried by the above method to reduce the moisture content. To prevent oxidation of the melt resin due to the remaining oxygen, drying is more preferably performed in an inert atmosphere (nitrogen, etc) in an extruder or with vacuum evacuating using an extruder having a vent. The screw compression ratio of the extruder is set to 2 to 5, and the L/D is set to 20 to 50. Here, “screw compression ratio” refers to the volume ratio of the feed section A to the conveyance and metering section C, and is represented by: (volume per unit length of the feed section A)/(volume per unit length of the conveyance and metering section C). This calculation uses the outer diameter d1 of the screw shaft of the feed section A, the outer diameter d2 of the screw shaft of the conveyance metering section C, the groove diameter a1 of the feed section A, and the groove diameter a2 of the conveyance metering section C. The L/D is the ratio of the cylinder length to the cylinder bore diameter.

Further, when the screw compression ratio is too small (below 2), the melt-kneading is insufficient, whereby unmelted portions can occur. As a result, shearing heat generation is too small and melting of the crystals is insufficient, whereby fine crystals are more likely to remain in the cellulose acylate film after production and air bubbles are also more likely to be mixed therein. As a consequence, when the strength of the cellulose acylate film deteriorates, or when the film is stretched, the residual crystals inhibit the stretching performance, thereby rendering it impossible for the alignment to be sufficiently increased. On the other hand, if the screw compression ratio is too large (exceeding 5), the resin is more susceptible to degradation from heat due to too great a shearing stress being applied, whereby yellowing tends to appear in the produced cellulose acylate film. In addition, if too great a shearing stress is applied, the molecules can shear, whereby the molecular weight is reduced and the mechanical strength of the film is decreased. Therefore, to make it less likely for yellowing to appear on the film, make the film stronger, and to make it less likely for stretching fractures to occur, the screw compression ratio is preferably in the range of 2 to 5, more preferably 2.5 to 4.5, and especially preferably 3.0 to 4.0.

Further, when the L/D is too small (below 20), melting and kneading may be insufficient. In the same manner as when the compression ratio is small, minute crystals tend to remain in the produced cellulose acylate film. On the other hand, when the L/D too large (above 50), the residence time of the cellulose acylate in the extruder is too long, and the resin is more susceptible to being degraded. In addition, if the residence time is longer, breaking of the molecules occurs, whereby the molecular weight is reduced and the mechanical strength of the film is decreased. Therefore, to make it less likely for yellowing to appear on the film, make the film stronger, and to make it less likely for stretching fractures to occur, L/D is preferably in the range of 20 to 50, more preferably 25 to 45, and especially preferably 30 to 40.

Preferably, the extrusion temperature is set to the above temperature range. The cellulose acylate film thus obtained has property values of a haze of 2.0% or less and yellowness index (YI value) of 10 or less.

Here, “haze” is an index of whether the extrusion temperature is too low or not; in other words, an index for determining the amount of crystal remaining in the produced cellulose acylate film. When the haze value is more than 2.0%, the strength of the produced cellulose acylate film may decrease and the film tends to be broken upon stretching. The yellowness index (YI value) is an index of whether the extrusion temperature is too high or not. A yellowness index (YI value) of 10 or less means that there is no problem of yellowing.

As to the types of extruders, generally single-screw extruders whose equipment cost is relatively low are often used. Types of the screw include a full-flight screw, a Maddock screw and a Dulmage screw. For cellulose acylate resins which have relatively poor thermal stability, full-flight screws are preferred.

Although the screw has different diameters depending on the intended extrusion amount per unit time, the diameter is preferably 10 mm or more to 300 mm or less, more preferably 20 mm or more to 250 mm or less, and even more preferably 30 mm or more to 150 mm or less.

(iii) Filtration

For filtering contaminants in the resin or avoiding damage to a gear pump due to such contaminants, a filter material is preferably disposed at the outlet of the extruder to perform so-called breaker plate type filtration. Also, to filter contaminants with a higher degree of accuracy, a filtering device incorporating so-called leaf disc filter is preferably disposed after the gear pump. One filtration area may be provided to perform filtration, or multi-stage filtration with a plurality of filtration areas may be performed. The higher the filtration accuracy the filter material has, the better. However, in view of the pressure resistance of the filter material and increase in the filtration pressure due to a clogged filter material, the filtration accuracy is preferably 3 μm to 15 μm, and more preferably 3 μm to 10 μm. In particular, when using leaf disc filter type equipment which filters contaminants at final stages, a filter material with high filtration accuracy is preferably used in view of quality. To ensure pressure resistance and an appropriate filter life, the number of filter materials to be installed may be adjusted. For such filter materials, steel materials are preferably used because they may be used at high temperatures under high pressures. Among such steel materials, stainless steel and steel are preferably used. For preventing corrosion, use of stainless steel is particularly desired. As to the structure of the filter material, those obtained by twisted wire or sintered filter materials formed by sintering metal filament or metal powder may be used. In view of filtration accuracy and filter life, sintered filter materials are preferred.

### (iv) Gear Pump

To improve the thickness accuracy, reducing fluctuation in the discharge amount is important. Providing a gear pump between the extruder and the die and feeding a constant amount of the cellulose acylate resin through the gear pump is effective. Such a gear pump has a pair of gears, i.e., a drive gear and a driven gear engaged with each other. By driving the drive gear to engage and rotate the two gears, molten resin is sucked into the cavity through a suction port formed on the housing, and the resin is discharged through a discharge port also formed on the housing in a constant amount. Even if the pressure of the resin at the tip of the extruder slightly fluctuates, such fluctuation is absorbed by the use of the gear pump, and thus the fluctuation in the pressure of the resin in the downstream of the film-forming machine becomes very small, and this improves thickness fluctuation. The fluctuation width in the pressure of the resin of the die portion can fall within ±1% using the gear pump.

To improve the capability of volumetric feeding of gear pumps, an approach of controlling the pressure before a gear pump at a constant value by changing the rotational number of the screw is also applicable. A high accuracy gear pump using three or more gears in which fluctuation in the gear is eliminated is also effective.

Other advantages of using a gear pump include, since film forming can be performed with a decreased pressure at the screw tip, reduction of energy consumption, prevention of increase in the resin temperature, improvement in transportation efficiency, shortening of the residence time in the extruder and reduction of the L/D in the extruder. Further, when using a filter for removing contaminants, the amount of the resin fed through the screw may fluctuate due to increase in the filtration pressure in the absence of a gear pump; this problem, however, can be solved by using a gear pump in combination. On the other hand, disadvantages of a gear pump include, depending on the equipment selection method, that the length of the equipment becomes longer, that the residence time of the resin becomes longer, and that the molecular chain may be severed by the shear stress of the gear pump section, and thus care is required.

A preferred residence time for a resin from being introduced into the extruder through a feed port to being discharged from the die is 2 minutes or more to 60 minutes or less, more preferably 3 minutes or more to 40 minutes or less, and even more preferably 4 minutes or more to 30 minutes or less.

If the flow of polymer for circulation in a bearing of the gear pump becomes poor, sealing with the polymer at the driving part and the bearing part becomes poor, causing problems such as large fluctuation in the pressure of measurement and the pressure of extrusion and feeding of liquid. Therefore, the gear pump (particularly clearance) needs to be designed to match the melt viscosity of the cellulose acylate resin. Further, in some cases, the residence part in the gear pump gives rise to deterioration of cellulose acylate resin, and therefore a structure with the smallest possible residence is preferred. Polymer tubes and adapters connecting the extruder and the gear pump or the gear pump and the die must also be designed with the smallest possible residence. In addition, for stabilization of the extrusion pressure of cellulose acylate resin whose melt viscosity is highly dependent on the temperature, fluctuation in the temperature is preferably kept as small as possible. Generally, a band heater whose equipment cost is low is often used for heating the polymer tube, but an aluminum cast heater with a smaller temperature fluctuation is more preferably used. Further, to stabilize the discharge pressure of the extruder as described above, melting is preferably performed by heating with a heater dividing the barrel of the extruder into 3 to 20 areas.

### (v) Die

A cellulose acylate resin is melted in an extruder configured as above, and the melt resin is continuously fed to a die, if necessary, through a filtering device and/or a gear pump. Any type of commonly used dies such as a T-die, a fish-tail die and a hanger coat die may be used as long as the die is designed so that the residence of the melt resin in the die is short. A static mixer may be disposed immediately before the T die in order to improve uniformity of the resin temperature. The clearance of the T die outlet is generally 1.0 to 5.0 times, preferably 1.2 to 3 times, and more preferably 1.3 to 2 times the film thickness. When the lip clearance is less than 1.0 time the film thickness, a well-formed sheet is difficult to obtain by film forming. When the lip clearance is larger than 5.0 times the film thickness, the uniformity in the thickness of the sheet is disadvantageously decreased. The die is a very important device for determining the thickness uniformity of the film, and a die capable of precisely controlling the thickness is preferred. The thickness is generally controllable in increments of 40 to 50 mm. Dies capable of controlling the film thickness in increments of preferably 35 mm or less, more preferably 25 ml or less are preferred. Since the melt viscosity of a cellulose acylate resin is highly dependent on the temperature and the shear rate, a design in which unevenness in the temperature of the die and unevenness in the flow rate in the width direction are as small as possible is essential. In addition, an automatic thickness control die in which the film thickness in the downstream is measured to calculate thickness deviation and the result is given as a feedback for controlling the thickness in the die is effective for reducing thickness fluctuation in long-term continuous production.

A single layer film-forming machine whose equipment cost is low is generally used for producing a film. In some cases, however, a multi-layer film-forming machine may also be used for forming a functional layer as an outer layer so as to produce a film having two or more structures. Generally, a thin functional layer is preferably stacked on the surface layer, and the ratio of the thickness of the layers is not particularly limited.

### (vi) Casting

In the above-described process, melt resin extruded in sheet form through a die is solidified by cooling on a cooling drum to give a film. In this step, contact between the cooling drum and the melt-extruded sheet is preferably improved using an electrostatic application method, an air knife method, an air chamber method, a vacuum nozzle method or a touch roll method. Such methods for improving contact may be performed on the entire surface of the melt-extruded sheet or on some part Particularly, a method called “edge pinning”, in which only both edges of the film are adhered, is often employed, but the method is not limited thereto.

Preferably, a plurality of cooling drums are used to gradually cool the resin. While using three cooling drums is rather common, the number of drums is not limited thereto. The cooling drum has a diameter of preferably 100 mm or more to 1,000 mm or less, and more preferably 150 mm or more to 1,000 mm or less. The interval between the plural cooling drums is 1 mm or more to 50 mm or less, and more preferably 1 mm or more to 30 mm or less.

The cooling drum is set to preferably 60° C. or more to 160° C. or less, more preferably 70° C. or more to 150° C. or less, and even more preferably 80° C. or more to 140° C. or less. The resin is then peeled off from the cooling drum and taken up through a take up drum (nip roll). The take-up rate is preferably 10 m/minute or more to 100 m/minute or less, more preferably 15 m/minute or more to 80 m/minute or less, and even more preferably 20 m/minute or more to 70 m/minute or less.

The filming width is preferably 0.7 m or more to 5 m or less, more preferably 1 m or more to 4 m or less, and even more preferably 1.3 m or more to 3 m or less. A non-stretched film thus obtained has a thickness of 30 μm or more to 400 μm or less, more preferably 40 μm or more to 300 μm or less, and even more preferably 50 μm or more to 200 μm or less.

When a so-called touch roll method is employed, the surface of the touch roll may be made of rubber or resin such as Teflon™, or a metal roll may also be used. A roll called a flexible roll obtained by reducing the thickness of the metal roll, whose roll surface is slightly depressed due to pressure upon touching and whose pressing area is thus increased may also be used.

The temperature of the touch roll is preferably 60° C. or more to 160° C. or less, more preferably 70° C. or more to 150° C. or less, and even more preferably 80° C. or more to 140° C. or less.

(vii) Take Up

Preferably, both ends of the sheet thus obtained are trimmed and the sheet is taken up. The trimmed portions may be crushed, or if necessary, granulated, depolymerized or polymerized again, and reused as a raw material for the same type of film or a different type of film. As a trimming cutter, any cutter such as a rotary cutter, a shear blade and a knife may be used. The material of the cutter may be either a carbon steel or a stainless steel. In general, use of a hard blade or a ceramic blade is preferred because they have a long life and generation of chips upon cutting can be reduced.

Before the take-up, a lamination film is preferably applied to at least one surface for preventing scars. The take-up tension is preferably 1 kg/m in width or more to 50 kg/m in width or less, more preferably 2 kg/m or more in width to 40 kg/m in width or less, and even more preferably 3 kg/m in width or more to 20 kg/m in width or less. When the take-up tension is less than 1 kg/m in width, uniform take up of the film is difficult. On the other hand, a tension of higher than 50 kg/m in width is not preferred because the film is tightly wound, and not only the appearance of the wound film becomes poor, but also raised portions in the film are extended due to creep, resulting in waving of the film, or residual birefringence being produced due to extension of the film. The take-up tension is detected by tension control along the line, and the film is preferably taken up while being controlled at a constant take-up tension. When the film temperature varies depending on the position in the film forming line, films may have a slightly different length due to thermal expansion. Accordingly, it is necessary that the drawing ratio of the nip rolls is adjusted so that a tension higher than a pre-determined tension is not applied to the film in the line.

The film can be taken up at a constant tension by the control in the tension control. More preferably, however, the tension is tapered proportional to the roll diameter to determine an appropriate take-up tension. Generally, the tension is gradually reduced as the roll diameter increases, but in some cases, the tension is preferably increased as the roll diameter increases.

(viii) Non-Stretched Cellulose Acylate Film Properties

The non-stretched cellulose acylate film thus obtained preferably has an Re of 0 to 20 nm and an Rth of 0 to 80 nm, more preferably an Re of 0 nm to 15 nm and an Rth of 0 to 70 nm, and even more preferably an Re of 0 to 10 nm and an Rth of 0 to 60 nm. Re, Rth each represent in-plane retardation and retardation in the thickness direction. The Re is measured by introducing light in the direction of the normal line of a film using a KOBRA 21ADH (made by Oji Scientific Instruments). The Rth is calculated from retardation values measured in three directions, i.e., the above Re and retardations measured by introducing light in the direction tilted +40° or −40° to the normal line of a film with the in-plane slow axis as an inclined axis (rotational axis). Further, the closer the angle θ between the film forming direction (longitudinal direction) and the slow axis of the Re of the film to 0°, +90° or −90°, the better.

The film has a total light transmittance of preferably 90% to 100%, more preferably 91 to 99%, and even more preferably 92 to 98%. Haze is preferably 0 to 1%, more preferably 0 to 0.8%, and even more preferably 0 to 0.6%.

Thickness unevenness in both the longitudinal direction and the width direction is preferably 0% or more to 4% or less, more preferably 0% or more to 3% or less, and even more preferably 0% or more to 2% or less.

The film has a tensile modulus of preferably 1.5 kN/mm² or more to 3.5 kN/mm² or less, more preferably 1.7 kN/mm² or more to 2.8 kN/mm² or less, and even more preferably 1.8 kN/mm² or more to 2.6 kN/mm² or less.

Elongation at break is preferably 3% or more to 100% or less, more preferably 5% or more to 80% or less, and even more preferably 8% or more to 50% or less.

The Tg (Tg of the film, namely, Tg of a mixture of cellulose acylate and additives) is preferably 95° C. or more to 145° C. or less, more preferably 100° C. or more to 140° C. or less, and even more preferably 105° C. or more to 135° C. or less.

The dimensional change due to heat of the film at 80° C. for one day is preferably 0% or more to ±1% or less, more preferably 0% or more to ±0.5% or less, and even more preferably 0% or more to ±0.3% or less in both the longitudinal and the transverse directions.

Water permeability at 40° C. and 90% rh is preferably 300 g/m² or more per day to 1,000 g/m² or less per day, more preferably 400 g/m² or more per day to 900 g/m² or less per day, and even more preferably 500 g/m² or more per day to 800 g/m² or less per day.

Equilibrium moisture content at 25° C. and 80% rh is preferably 1 wt. % or more to 4 wt. % or less, more preferably 1.2 wt. % or more to 3 wt. % or less, and even more preferably 1.5 wt. % or more to 2.5% wt. % or less.

### (8) Stretching

The film produced according to the above-described method can also be stretched, thereby allowing Re and Rth to be controlled.

Stretching is preferably conducted between Tg (° C.) or higher and Tg+50° C. or lower, more preferably between Tg+3° C. or higher and Tg+30° C. or lower, and even more preferably between Tg+5° C. or higher and Tg+20° C. or lower. A preferable stretch ratio is from 1% or more to 300% or less, more preferably from 2% or more to 250% or less, and even more preferably from 3% or more to 200% or less to at least one end. While the length and width may be equally stretched, it is more preferable to make one of the stretch ratios greater than the other to stretch in an unequal manner. Either the length (MD) or width (TD) may be made larger. The smaller stretch ratio is preferably from 1% or more to 30% or less, more preferably from 2% or more to 25% or less, and even more preferably from 3% or more to 20% or less. The larger stretch ratio is preferably from 30% or more to 300% or less, more preferably from 35% or more to 200% or less, and even more preferably from 40% or more to 150% or less. Such stretching may be completed by one stretching procedure or by several stretching procedures. The term “stretch ratio” as used here is determined using the below equation.

Stretch ratio (%)=100×{(length after stretching)−(length before stretching)}/(length before stretching)

Stretching can be performed in a longitudinal direction using two or more pairs of nip rolls whose peripheral speed is higher at the outlet side (longitudinal stretching), or can be performed by gripping the film at both edges with a chuck and spreading in an orthogonal direction (orthogonal to the longitudinal direction) (transverse stretching). In addition, the simultaneous twin screw stretching methods described in Japanese Patent Application Laid-Open Nos. 2000-37772, 2001-113591, and 2002-103445 may also be employed.

For longitudinal stretching, controlling the value (length to width ratio) obtained by dividing nip roll gap by film width enables the ratio between Re and Rth to be freely controlled. That is, by making the length to width ratio smaller, the Rth/Re ratio can be made larger. Re and Rth can also be controlled by combining the longitudinal stretching and transverse stretching. That is, by decreasing the difference between the longitudinal stretching ratio and the transverse stretching ratio, Re can be made smaller, and by increasing the difference, Re can be made larger.

It is therefore preferable for the Re and Rth of a stretched cellulose acylate film to satisfy the below equation.

Rth≧Re

200≧Re≧0

500≧Rth≧30; and more preferably,

Rth≧Rex1.1

150≧Re≧10

400≧Rth≧50; and even more preferably

Rth≧Rex 1.2

100≧Re≧20

350≧Rth≧80

The closer the angle θ formed between the film-forming direction (longitudinal direction) and the film Re slow axis is to 0°, +90° or −90°, the better it is. That is, for longitudinal stretching, the closer to 0° the better, so that 0±3° is preferable, 0±2° is more preferable, and 0±1° is even more preferable. For transverse stretching, 90±3° or −90±3° is preferable, 90±2° or −90±2° is more preferable, and 90±1° or −90±1° is even more preferable.

The thicknesses of the cellulose acylate films after stretching are preferably 15 km or more to 200 μm or less, more preferably 30 μm or more to 170 μm or less, and even more preferably 40 μm or more to 140 μm or less. Thickness unevenness in both the longitudinal and width directions is preferably from 0% or more to 3% or less, more preferably from 0% or more to 2% or less, and even more preferably from 0% or more to 1% or less.

The physical properties of the stretched cellulose acylate films are preferably within the bellow range.

Tensile elasticity is preferably from 1.5 kN/mm² or more to less than 3.0 kN/mm², more preferably from 1.7 kN/mm² or more to 2.8 kN/mm² or less, and even more preferably from 1.8 kN/mm² or more to 2.6 kN/mm² or less.

Elongation at break is preferably from 3% or more to 100% or less, more preferably from 5% or more to 80% or less and even more preferably from 8% or more to 50% or less.

Tg (meaning the film Tg; i.e. the Tg of the mixture consisting of cellulose acylate and additives) is preferably from 95° C. or more to 145° C. or less, more preferably from 100° C. or more to 140° C. or less and even more preferably from 105° C. or more to 135° C. or less.

The thermal dimensional change at 80° C. for one day is, for both length and width directions, preferably from 0% or more to ±1% or less, more preferably from 0% or more to ±0.5% or less, and even more preferably from 0% or more to ±0.3% or less.

Water permeability coefficient at 40° C. and 90% rh is preferably 300 g/m² per day or more to 1,000 g/m² per day or less, more preferably 400 g/m² per day or more to 900 g/m² per day or less, and even more preferably 500 g/m² per day or more to 800 g/m² per day or less.

The equilibrium moisture content at 25° C. and 80% rh is preferably from 1 wt. % or more to 4 wt. % or less, more preferably from 1.2 wt. % or more to 3 wt. % or less, and even more preferably from 1.5 wt. % or more to 2.5 wt. % or less.

Thickness is preferably 30 μm or more to 200 μm or less, more preferably 40 μm or more to 180 μm or less, and even more preferably 50 μm or more to 150 μm or less.

The haze is from 0% or more to 3% or less, more preferably from 0% or more to 2% or less, and even more preferably from 0% or more to 1% or less.

Total light transmittance is preferably 90% or more to 100% or less, more preferably 91% or more to 99% or less, and even more preferably 92% or more to 98% or less.

### (9) Surface Treatment

It is possible to improve adhesion between a stretched or non-stretched cellulose acylate film and each functional layer (e.g., an undercoat layer or a backing layer) by subjecting the film to a surface treatment. For example, a glow discharge treatment, UV ray irradiation treatment, corona treatment, flame treatment or treatment with an acid or an alkali may be employed. The glow discharge treatment may be a plasma treatment using a low-temperature plasma generated under a low-pressure gas of 10⁻³ to 20 Torr, and a plasma treatment under atmospheric pressure is also preferable. The term “plasma forming gas” refers to a gas which is plasma-excited is under the above-mentioned conditions. Examples thereof include argon, helium, neon, krypton, xenon, nitrogen, carbon dioxide, flons such as tetrafluoromethane, and mixtures thereof. Detailed descriptions thereon are given in Journal of Technical Disclosure (Kokai Giho) (Kogi No. 2001-1745, published on Mar. 15, 2001 by Japan Institute of Invention and Innovation) on pages 30 to 32. Additionally, plasma treatment under atmospheric pressure which has been noted in recent years employs an irradiation energy of, for example, from 20 to 500 kGy under 10 to 1,000 keV, and more preferably from 20 to 300 kGy under 30 to 500 keV. Of these, an alkali saponification treatment is particularly preferred, and is extremely effective for surface treatment of a cellulose acylate film. Specifically, Japanese Patent Application Laid-Open Nos. 2003-3266, 2003-229299, 2004-322928, 2005-76088 and the like may be employed.

The alkali saponification treatment may be conducted by dipping in a saponifying solution or by coating a saponifying solution. With the dipping method, the cellulose acylate film is passed through a tank for 0.1 to 10 minutes, which contains an aqueous solution of NaOH, KOH or the like having a pH of from 10 to 14 and being heated to 20° C. to 80° C., followed by neutralization, washing with water and drying.

Examples of the coating method which can be employed include dip coating, curtain coating, extrusion coating, bar coating, or E-type coating. The solvent for the coating solution to be used for the alkali saponification treatment is preferably selected as a solvent which has good wettability to coat the transparent support of the saponifying solution and which can keep a good surface state without forming unevenness on the surface of the transparent support from the saponifying solution. Specifically, alcoholic solvents are preferred, with isopropyl alcohol being particularly preferred. It is also possible to use an aqueous solution of a surfactant as the solvent. The alkali to be used in the coating solution for alkali treatment is preferably an alkali which dissolves in the above-described solvent, with KOH and NaOH being more preferred. The pH of the coating solution for saponification treatment is preferably 11 or more, and more preferably 12 or more. The reaction conditions for the alkali saponification are preferably at room temperature and for from 1 second or more to 5 minutes or less, more preferably from 5 seconds or more to 5 minutes or less, and particularly preferably from 20 seconds or more to 3 minutes or less. After completion of the alkali saponification reaction, the saponification solution-coated surface is preferably washed with water or with an acid then water. Furthermore, the coating saponification treatment may be conducted immediately before coating of an alignment layer (described hereinafter), which contributes to a reduction of the number of steps. These saponification methods are specifically described in, for example, Japanese Patent Application Laid-Open No. 2002-82226 and WO 02/46809.

It is also preferred to provide an undercoat layer for adhesion to a functional layer. This undercoat layer may be provided by coating after the above-described surface treatment, or may be provided without the surface treatment. Detailed descriptions on the undercoat layer are given in Journal of Technical Disclosure (Kokai Giho) (Kogi No. 2001-1745, published by Japan Institute of Invention and Innovation on Mar. 15, 2001), on page 32.

The surface treatment and the undercoating step can be provided at the final stage of the film-production process, and may be conducted independently or during the step of providing a functional layer to be described hereinafter.

### (10) Functional Layer Provision

It is preferred to combine the stretched or non-stretched cellulose acylate film of the present invention with functional layers as described in detail in Journal of Technical Disclosure (Kokai Giho) (Kogi No. 2001-1745, published by Japan Institute of Invention and Innovation on Mar. 15, 2001) on pages 32 to 45. Preferable among such layers are a polarizing layer (to form a polarizing plate), an optical compensation layer (to form an optical compensation film), an antireflective layer (to form an antireflective film), and a hard coat layer.

### (i) Providing a Polarizing Layer (Preparation of a Polarizing Plate)

### [Materials to be Used for the Polarizing Layer]

At present, commercially available polarizing films are generally prepared by dipping a stretched polymer in a solution of iodine or a dichroic dye retained in a tank to thereby permeate iodine or the dichroic eye into the binder. As the polarizing film, a coating type polarizing film represented by that produced by Optiva Inc. may also be used. The iodine or dichroic dye in the polarizing film is aligned in the binder to exhibit its polarizing ability. Examples of dichroic dyes which can be used include azo dyes, stilbene dyes, pyrazolone dyes, triphenylmethane dyes, quinoline dyes, oxazine dyes, thiazine dyes or anthraquinone dyes. The dichroic dye is preferably water-soluble. The dichroic dye preferably has a hydrophilic substituent (e.g., a sulfo group, an amino group or a hydroxyl group). Examples thereof include the compounds described in Journal of Technical Disclosure (Kokai Giho), Kogi No. 2001-1745, on page 58 (published on Mar. 15, 2001).

As the polarizing film binder, either a polymer which itself can cause cross-linking or a polymer which can be linked with a cross-linking agent may be used, and a plurality of combinations thereof may be used. The binder can be a methacrylate copolymer, styrenic copolymer, polyolefin, polyvinyl alcohol PVA or modified polyvinyl alcohol, poly(N-methylolacrylamide), polyester, polyimide, vinyl acetate copolymer, carboxymethyl cellulose or polycarbonate described in, for example, Japanese Patent Application Laid-Open No. 8-338913, paragraph [0022]. A silane coupling agent may also be used as the polymer Preferred examples include water-soluble polymers (e.g., poly(N-methylolacrylamide), carboxymethyl cellulose, gelatin, polyvinyl alcohol, and modified polyvinyl alcohol). More preferred are gelatin, polyvinyl alcohol and modified polyvinyl alcohol, and most preferred are polyvinyl alcohol and modified polyvinyl alcohol. It is particularly preferred to use two polyvinyl alcohols or modified polyvinyl alcohols having a different polymerization degree. The saponification degree of the polyvinyl alcohol is preferably from 70 to 100%, and more preferably from 80 to 100%. The polymerization degree of the polyvinyl alcohol is preferably from 100 to 5,000. Descriptions regarding the modified polyvinyl alcohol are given in Japanese Patent Application Laid-Open Nos. 8-338913, 9-152509, and 9-316127. The polyvinyl alcohol and modified polyvinyl alcohol may be used in combination of two or more thereof.

The lower limit of the binder thickness is preferably 10 μm. In view of light leakage of an image display device, the smaller thickness the better. Therefore, the thickness upper limit is preferably equal to or smaller than the thickness of presently commercially available polarizing plates (about 30 μm), more preferably equal to or smaller than 25 μm, and particularly preferably equal to or smaller than 20 μm.

The polarizing film binder may be cross-linked. The binder may contain a polymer or monomer having a cross-linkable functional group, or the binder polymer itself may possess a cross-linkable functional group. Cross-linking may be caused by light, heat or change in pH, whereby a binder can be formed having a cross-linked structure. Descriptions regarding the cross-linking agent are given in U.S. Reissued Pat. No. 23,297. Moreover, a boron compound (e.g., boric acid or borax) may be used as the cross-linking agent. The addition amount of the cross-linking agent for the binder is preferably from 0.1 to 20% by mass of the binder, whereby the alignment properties of the polarizing element and resistance to moist heat of the polarizing film improve.

The amount of the unreacted cross-linking agent at the completion of the cross-linking reaction is preferably 1.0% by mass or less, and more preferably 0.5% by mass or less. Such an amount serves to improve weatherability.

### [Polarizing Film Stretching]

The polarizing film is preferably dyed with iodine or a dichroic dye after being stretched (stretching method) or rubbed (rubbing method).

With the stretching method, the stretch ratio is preferably from 2.5 to 30.0, and more preferably from 3.0 to 10.0. The stretching can be conducted by dry stretching in air. Also, wet stretching may be employed in a state of being dipped in water. The stretch ratio for dry stretching is preferably from 2.5 to 5.0, and the stretch ratio for wet stretching is preferably from 3.0 to 10.0. The stretching may be conducted in a direction parallel to the MD direction (parallel stretching) or in a slanted direction (slanted stretching). Such stretching may be completed by one stretching procedure or by several stretching procedures. By breaking up into several stretching procedures, a stretching can be conducted more uniformly even at a high stretch ratio. More preferred is a slanted stretching wherein stretching is conducted in a slant direction with a slant of from 10° to 80°.

### (I) Parallel Stretching Method

A PVA film is swollen prior to stretching. The swelling degree (ratio of mass after swelling to that before swelling) is from 1.2 to 2.0. Subsequently, the film is stretched in an aqueous medium bath or in a dying bath containing dissolved therein a dichroic substance at a bath temperature of from 15 to 50° C., preferably from 17 to 40° C., while continuously conveying via guide rolls. Stretching can be performed by gripping with two pairs of nip rolls, with the conveying speed of the nip rolls at the latter position being faster than that of the nip rolls at the former position. The stretch ratio is based on the ratio of the length after stretching/the initial length (hereinafter the same). In view of the above-described effects, the stretch ratio is from 1.2 to 3.5, and preferably from 1.5 to 3.0. Thereafter, the film is dried at a temperature of from 50° C. to 90° C. to obtain a polarizing film.

### (II) Slanted Stretching Method

The method described in Japanese Patent Application Laid-Open No. 2002-86554 may be employed, wherein stretching is conducted using a tenter which overhangs in a slanted direction. Since this stretching is conducted in air, it is necessary to make stretching easier by incorporating water therein. The water content is preferably from 5% or more to 100% or less, the stretching temperature is preferably from 40° C. or more to 90° C. or less, and the humidity during stretching is preferably from 50% rh or more to 100% rh or less.

The absorption axis of the thus-obtained polarizing film is preferably from 10° to 80°, more preferably from 30° to 60°, and particularly preferably substantially 45° (40° to 50°).

### [Lamination]

The saponified and stretched or non-stretched cellulose acylate film and the stretched polarizing layer are laminated to each other to prepare a polarizing plate. The lamination direction is not particularly limited, but lamination is preferably conducted so that the angle between the direction of conveying axis of the cellulose acylate film and the direction of the stretching axis of the polarizing plate is any of 0°, 45° or 90°.

The adhesive used for lamination is not particularly limited, and examples thereof include PVA resins (such as modified PVA having an acetoacetyl group, sulfonic acid group, carboxyl group or oxyalkylene group), and an aqueous solution of a boron-containing compound. Among them, the PVA resins are preferred. The thickness of the adhesive layer after drying is preferably from 0.01 to 10 μm, and particularly preferably from 0.05 to 5 μm.

Examples of the laminated layer structure can include the following.

a) A/P/A

b) A/P/B

c) A/P/T

d) B/P/B

e) B/P/T

Here, reference character “A” designates a non-stretched film according to the present invention, reference character “B” designates a stretched film according to the present invention, reference character “T” designates a cellulose triacetate film (FUJI TAC), and reference character “P” designates a polarizing layer. In the case of the “a)” and “b)” structures, A and B may have the same or different cellulose acetate compositions. In the case of the “d)” structure, B may have the same or different cellulose acetate compositions, and the stretch ratios may also be the same or different. When such structures are incorporated into a liquid crystal display device for use, any may serve as the liquid crystal face. However, when using the structures “b)” or “e)”, it is more preferable to provide B on the display side.

When incorporating into a liquid crystal display device, while a substrate comprising the liquid crystals in between two polarizing plates is usually provided, the structures of “a)” to “e)” and the ordinary polarizing plate (T/P/T) may be freely incorporated. However, it is preferable to provide a transparent hard coat layer, an anti-glare layer, an anti-reflective layer and the like on the uppermost face film of the liquid crystal display device. Layers which shall be described below may be used.

The higher the light transmittance and the polarizing degree of the thus-obtained polarizing plate, the better. The light transmittance of the polarizing plate for 550 nm wavelength light is preferably in the range of from 30 to 50%, more preferably from 35 to 50%, and most preferably from 40 to 50%. The polarizing degree for 550 nm wavelength light is preferably in the range of from 90 to 100%, more preferably from 95 to 100%, and most preferably from 99 to 100%.

Further, the thus-obtained polarizing plate can be laminated to a λ/4 plate to prepare a circularly polarizing plate. In such a case, lamination is conducted so that the angle between the slow axis of the λ/4 plate and the absorption axis of the polarizing plate is 45°. The λ/4 plate is not particularly limited, but preferably has such wavelength dependence that retardation becomes smaller as the wavelength becomes shorter. Further, it is preferred to use a λ/4 plate comprising a polarizing film having an absorption axis inclined at an angle of from 20° to 70° with respect to the longitudinal direction and an optical anisotropic layer comprising a liquid crystalline compound.

A protective film may be provided on one of the faces of these polarizing plates, and a separating film may be provided on the opposite face. The purpose of protective film and separating film is to protect the polarizing plates during optical plate shipment, product inspection and the like.

### (ii) Providing an Optical Compensation Layer (Preparation of an Optical Compensation Layer)

The optical anisotropic layer serves to compensate the liquid crystalline compound in the liquid crystal cells during black display of a liquid crystal display device. Such a layer is formed by forming an alignment film on a stretched or non-stretched cellulose acylate film, then further providing an optical anisotropic layer.

### [Alignment Layer]

An alignment film is provided on a stretched or non-stretched cellulose acylate film which has undergone the above-described surface treatment. The alignment film has a function of deciding the alignment direction of the liquid crystal molecules. However, if the alignment state of the liquid crystalline compound is fixed after the compound is aligned the alignment film is not always necessary as a component of the present invention because its function has been fulfilled. That is, it is possible to transfer only the optical anisotropic layer having a fixed alignment state on the alignment film onto a polarizing element to thereby prepare the polarizing plate according to the present invention.

The alignment film can be provided by, for example, a rubbing treatment of an organic compound (preferably a polymer), oblique vacuum deposition of an inorganic compound, or formation of a layer having microgrooves or accumulation of an organic compound (e.g., ω-tricosanoic acid, dioctadecylmethylammonium chloride or methyl stearate) by Langmuir-Blodgett method (LB membrane). Further, there are known alignment films which generate their aligning function when an electric field or a magnetic field is applied thereto or when they are irradiated with light.

The alignment film is formed preferably by rubbing treatment of a polymer. The polymer to be used for the alignment film has, in principle, a molecular structure capable of aligning liquid crystal molecules.

In the present invention, in addition to the function of aligning liquid crystal molecules, it is preferred to bind a side chain having a cross-linkable functional group (e.g., a double bond) to the main chain or to introduce a cross-linkable functional group having a function of aligning liquid crystal molecules to the side chain.

As the polymer to be used for the alignment film, either of a polymer which itself can cause cross-linking or a polymer which can be cross-linked with a cross-linking agent can be used. It is also possible to employ plural combinations thereof. Examples of the polymer include methacrylate copolymers styrenic copolymers, polyolefins, polyvinyl alcohol and modified polyvinyl alcohol, poly(N-methylolacrylamide), polyesters, polyimides, vinyl acetate copolymers, carboxymethyl cellulose and polycarbonates described in, for example, Japanese Patent Application Laid-Open No. 8-338913, paragraph [0022]. It is also possible to use a silane coupling agent as the polymer. Water-soluble polymers (e.g., poly(N-methylolacrylamide), carboxymethyl cellulose, gelatin, polyvinyl alcohol and modified polyvinyl alcohol) are preferred, gelatin, polyvinyl alcohol and modified polyvinyl alcohol are more preferred, and polyvinyl alcohol and modified polyvinyl alcohol are most preferred. It is particularly preferred to use two or more polyvinyl alcohols or modified polyvinyl alcohols having differing polymerization degrees in combination thereof. The saponification degree of the polyvinyl alcohol is preferably from 70 to 100%, and more preferably from 80 to 100%. The polymerization degree of the polyvinyl alcohol is preferably from 100 to 5,000.

The side chain having a function of aligning liquid crystal molecules generally has a hydrophobic group as a functional group. The specific kind of functional group is decided depending upon the kind of liquid crystal molecule and necessary alignment state. For example, a modifying group for the modified polyvinyl alcohol can be introduced by modification by copolymerization, modification by chain transfer or modification by block polymerization. Examples of the modifying group include a hydrophilic group (e.g., a carboxylic acid group, a sulfonic acid group, a phosphonic acid group, an amino group, an ammonium group, an amide group, or a thiol group), a hydrocarbon group having carbon number from 10 to 100, a fluorine atom-substituted hydrocarbon group, a thioether group, a polymerizable group (e.g., an unsaturated polymerizable group, an epoxy group or an aziridinyl group) or an alkoxysilyl group (e.g., trialkoxy, dialkoxy or monoalkoxy). Specific examples of these modified polyvinyl alcohol compounds include those which are described in, for example, Japanese Patent Application Laid-Open No. 2000-155216, paragraphs [0022] to [0145], and Japanese Patent Application Laid-Open No. 2002-62426, paragraphs [0018] to [0022].

The polymer of the alignment film and the multi-functional monomer contained in the optical anisotropic layer can be copolymerized with each other by either connecting a side chain having a cross-linkable functional group to the main chain of the alignment film polymer or by introducing a cross-linkable functional group into the side chain having the function of aligning liquid crystal molecules. As a result, strong covalent bonds are formed between one alignment film polymer and another alignment film polymer and between the multi-functional monomer and the alignment film polymer as well as between one multi-functional monomer and another multi-functional monomer. Thus, the strength of the optical compensation film can be remarkably improved by introducing a cross-linkable functional group into the alignment film polymer.

The cross-linkable functional group of the alignment film polymer preferably contains a polymerizable group, as is the case with the multi-functional monomer. Specific examples thereof include those described in, for example, Japanese Patent Application Laid-Open No. 2000-155216, paragraphs [0080] to [0100]. In addition to the above-mentioned cross-linkable functional group, the alignment film polymer can also be cross-linked using a cross-linking agent.

Examples of the cross-linking agent include aldehydes, N-methylol compounds, dioxane derivatives, compounds capable of functioning as a cross-linking agent by activating a carboxyl group, active vinyl compounds, active halogen-containing compounds, isoxazoles, and dialdehyde starches. Two or more of the cross-linking agents may be used in combination thereof. Specific examples include those compounds which are described in, for example, Japanese Patent Application Laid-Open No. 2002-62426, paragraphs [0023] and [0024]. A highly reactive aldehyde is preferred, with glutaraldehyde being particularly preferred.

The addition amount of the cross-linking agent is preferably from 0.1 to 20% by mass, and more preferably from 0.5 to 15% by mass, of the polymer. The amount of unreacted cross-linking agent remaining in the alignment film is preferably equal to or less than 1.0% by mass, and more preferably equal to or less than 0.5% by mass. Such an amount ensures sufficient durability with no reticulation even if the alignment film is used for a long time in a liquid crystal display device or left for a long period in a high-temperature and high-humidity atmosphere.

The alignment film can be formed basically by coating onto a transparent support a coating solution containing the above-described polymer, which is a material for forming the alignment film, and a cross-linking agent, drying under heating (to cross-link), then subjecting the coated support to rubbing treatment. As described above, the cross-linking reaction may be conducted at any stage after the coating of the coating solution onto the transparent support. In the case of using a water-soluble polymer such as polyvinyl alcohol as the alignment film-forming material, the coating solution is preferably prepared by using a mixed solvent consisting of an organic solvent (e.g., methanol) having an anti-foaming function and water. The mixing ratio of water:methanol in terms of mass ratio is preferably 0:100 to 99:1, and more preferably from 0:100 to 91:9. With such a ratio, the generation of foam is suppressed, and defects in the alignment film and, further, defects in the surface of the optically anisotropic layer are dramatically reduced.

Preferred examples of a method for coating the alignment film include spin coating, dip coating, curtain coating, extrusion coating, rod coating or roll coating. Rod coating is particularly preferred. The thickness of the alignment film after being dried is preferably from 0.1 to 10 μm. The drying under heating can be conducted at a temperature of from 20° C. to 110° C. In order to form sufficient cross-linking, the temperature is preferably from 60° C. to 100° C., and more preferably from 80° C. to 100° C. The drying time can be from 1 minute to 36 hours, and is preferably from 1 minute to 30 minutes. The pH is preferably set to an optimal level for the cross-linking agent which will be used. In the case of using glutaraldehyde, the pH is preferably from 4.5 to 5.5, and particularly preferably is 5.

The alignment film may be provided on a stretched or non-stretched cellulose acylate film or on the above-described undercoat layer. The alignment film can be obtained by cross-linking the polymer layer as described above, then subjecting the surface thereof to a rubbing treatment.

As the rubbing treatment, a treating method widely employed as a method for aligning the liquid crystals of an LCD can be applied. Specifically, a method can be employed which achieves alignment by rubbing the surface of the alignment film in a constant direction with paper, gauze, felt, rubber, nylon fibers or polyester fibers. In general, the rubbing treatment is conducted by rubbing several times using a cloth or similar uniformly implanted with fibers having a uniform length and thickness.

In the case of conducting on an industrial scale, the rubbing treatment can be conducted by bringing a film having the polarizing layer, while conveying the film, into contact with a rotating rubbing roll. The roundness, cylindricity and deflection (eccentricity) of the rubbing roll are all preferably 30 μm or less. The lapping angle of the film with respect to the rubbing roll is preferably from 0.1 to 90°. However, as is described in Japanese Patent Application Laid-Open No. 8-160430, it is also possible to perform stable rubbing treatment by winding 360° or more. The film conveying rate is preferably from 1 m/min to 100 m/min. It is preferable to select a proper rubbing angle in the range of from 0 to 60°. If using in a liquid crystal display device, the angle is preferably from 40 to 50°, with 45° being particularly preferred.

The thickness of the thus-obtained alignment film is preferably in the range of from 0.1 to 10 μm.

Next, the liquid crystal molecules of the optical anisotropic layer are aligned on the alignment film. Subsequently, as needed, the alignment film polymer is cross-linked by reacting the alignment film polymer with the multi-functional monomer contained in the optical anisotropic layer or by using a cross-linking agent.

The liquid crystal molecules used in the optical anisotropic layer may be rod-like liquid crystal molecules or discotic liquid crystal molecules. The rod-like liquid crystal molecules and discotic liquid crystal molecules may be high molecular liquid crystals or low molecular liquid crystals. Further, they may also be those wherein low molecular liquid crystal molecules have been cross-linked to thereby lose their liquid crystal properties.

### [Rod-Like Liquid Crystal Molecules]

Preferable examples of rod-like liquid crystal molecules which can be used include azomethines, azoxy compounds, cyanobiphenyls, cyanophenylesters, benzoates, phenyl cyclohexanecarboxylates, cyanophenylcyclohexanes, cyano-substituted phenylpyridines, alkoxy-substituted phenylpyrimidines, phenyldioxanes, tolans and alkenylcyclohexylbenzonitriles.

Additionally, the rod-like liquid crystal molecules may also be metal complexes. Also, liquid crystal polymers containing a rod-like liquid crystalline molecule in repeating units thereof can be used as the rod-like liquid crystal molecules. In other words, the rod-like liquid crystal molecules may be bound to a (liquid crystal) polymer.

Descriptions regarding rod-like liquid crystal molecules are given in the quarterly Kagaku Sosetsu, vol. 22, Ekisho No Kagaku (1994), compiled by Nihon Kagakukai, chapters 4, 7 and 11, and the Ekisho Device Handbook, compiled by Nihon Gakujutsu Shinkokai 142^{nd} Iinkai, chapter 3.

The birefringence of the rod-like liquid crystal molecules is preferably in the range of from 0.001 to 0.7.

The rod-like liquid crystal molecules preferably have a polymerizable group in order to fix their alignment state. The polymerizable group is preferably a radical-polymerizable unsaturated group or a cation-polymerizable group. Specific examples include the polymerizable groups and polymerizable liquid crystal compounds described in, for example, Japanese Patent Application Laid-Open No. 2002-62427, paragraphs [0064] to [0086].

### [Discotic Liquid Crystal Molecules]

Examples of the discotic liquid crystal molecules include the benzene derivatives described in a report by C. Destrade et al., Mol. Cryst., 71, 111 (1981); the truxene derivatives described in reports by C. Destrade et al., Mol. Cryst., 122, 141 (1985), Physics lett, A, 78, 82 (1990); the cyclohexane derivatives described in a report by B. Kohne et al., Angew. Chem., 96, 70 (1984); and the azacrown or phenylacetylene macrocycles described in a report by J. M. Lehn et al., J. Chem. Commun., 1794 (1985) and a report by J. Zhang et al., J. Am. Chem. Soc., 116, 2665 (1994).

Examples of the discotic liquid crystal molecules include compounds which exhibit liquid crystallinity that have a structure wherein straight-chain alkyl groups, alkoxy groups or substituted benzoyloxy groups are substituted in a radial pattern as side chains around a parent nucleus. The molecules or aggregate of the molecules preferably have rotational symmetry, and such compound can preferably impart a constant alignment. In an optical anisotropic layer formed by the discotic liquid crystal molecules, the compound finally contained in the optical anisotropic layer does not necessarily comprise discotic liquid crystal molecules. For example, such compound may comprise low molecular discotic liquid crystal molecules having a group capable of reacting with heat or light, which undergoes a polymerization or cross-linking reaction from the heat or light to form a higher molecular weight compound that has lost its liquid crystallinity. Preferred examples of the discotic liquid crystal molecules are described in Japanese Patent Application Laid-Open No. 8-50206. A description regarding the polymerization of discotic liquid crystal molecules is given in Japanese Patent Application Laid-Open No. 8-27284.

In order to fix the discotic liquid crystal molecules by polymerization, it is necessary to bind a polymerizable group as a substituent to a discotic core of the discotic liquid crystalline molecules. Compounds wherein the discotic core and the polymerizable group are bound to each other through a linking group are preferred, since alignment state can be maintained in the polymerization reaction. Examples of such compounds are described in, for example, Japanese Patent Application Laid-Open No. 2000-155216, paragraphs [0151] to [0168].

In hybrid alignment, the angle between the longer axis of the discotic liquid crystalline molecule (discotic plane) and the plane of the polarizing film increases or decreases as the distance from the plane of the polarizing film increases in the depth direction of the optical anisotropic layer. The angle preferably decreases as the distance increases. Further, the change of the angle can be a continuous increase, a continuous decrease, an intermittent increase, an intermittent decrease, a change including both continuous increase and continuous decrease, or an intermittent change including an increase and a decrease. Intermittent change can include regions wherein the oblique angle does not change in the middle of the thickness direction. Even if the angle contains regions which do not change, it is acceptable as long as the angle either increases or decreases as a whole. However, it is preferred that the angle changes in a continuous manner.

The average direction of the longer axis of the discotic liquid crystal molecules on the polarizing film side can generally be adjusted by selecting the material of the discotic liquid crystal molecules or the alignment film, or by selecting the method of rubbing treatment. Further, the direction of the longer axis of the discotic liquid crystal molecules (discotic plane) on the surface side (air side) can generally be adjusted by selecting the kind of discotic liquid crystal molecule or the kind of additive to be used together with the discotic liquid crystal molecules. Examples of the additive to be used together with the discotic liquid crystal molecules include a plasticizer, a surfactant, a polymerizable monomer and a polymer. The degree of change in the alignment direction of the longer axis can similarly be adjusted by selecting the kind of liquid crystal molecule and the additive.

### [Other Constituents of the Optical Anisotropic Layer]

Uniformity of a coated film, film strength and aligning properties of the liquid crystal molecules can be improved by using a plasticizer, a surfactant or a polymerizable monomer together with the above-mentioned liquid crystal molecules. As such constituents, those which have a good compatibility with the liquid crystal molecules and can impart change in the oblique angle of the liquid crystal molecules or do not inhibit alignment are preferred.

Examples of the polymerizable monomer include radical-polymerizable compounds and cation-polymerizable compounds. Preferred is a multi-functional, radical-polymerizable monomer which is copolymerizable with the polymerizable group-containing liquid crystal compound described above Examples thereof include those described in Japanese Patent Application Laid-Open No. 2002-296423, paragraphs [0018] to [0020]. The addition amount of the compound is generally in the range of from 1 to 50% by mass, preferably from 5 to 30% by mass of the discotic liquid crystal molecules.

Examples of the surfactant can include conventionally known compounds, and fluorine-containing compounds are particularly preferred. Specific examples are the compounds described in Japanese Patent Application Laid-Open No. 2001-330725, paragraphs [0028] to [0056].

The polymer to be used together with the discotic liquid crystal molecules preferably imparts change in the oblique angle to the discotic liquid crystalline molecules.

Examples of the polymer include cellulose esters. Preferred examples of cellulose esters include those described in Japanese Patent Application Laid-Open No. 2000-155216, paragraph [0178]. The addition amount of the polymer is in the range of preferably from 0.1 to 10% by mass, more preferably from 0.1 to 8% by mass of the liquid crystal molecules in order not to inhibit alignment of the liquid crystal molecules.

The temperature at which phase transition takes place between the discotic-nematic liquid crystal phase and the solid phase of the discotic liquid crystal molecules is preferably from 70 to 300° C., and more preferably from 70 to 170° C.

### [Formation of the Optical Anisotropic Layer]

The optical anisotropic layer can be formed by coating on an alignment film a coating solution containing liquid crystal molecules and, as needed, a below-described polymerization initiator and an optional component.

An organic solvent is preferably used as the solvent used for preparing the coating solution. Examples of organic solvents include amides (e.g., N,N-dimethylformamide), sulfoxides (e.g., dimethylsulfoxide), hetero ring compounds (e.g., pyridine), hydrocarbons (e.g., benzene and hexane), alkylhalides (e.g., chloroform, dichloromethane and tetrachloroethane), esters (e.g., methyl acetate and butyl acetate), ketones (e.g., acetone and methyl ethyl ketone), and ethers (e.g., tetrahydrofuran and 1,2-dimethoxyethane). Preferable are alkylhalides and ketones. Two or more of the organic solvents may be used in combination thereof.

Coating of the coating solution can be conducted by a known method (e.g., wire bar coating, extrusion coating, direct gravure coating, reverse gravure coating, or die coating).

The thickness of the optical anisotropic layer is preferably from 0.1 to 20 μm, more preferably from 0.5 to 15 μm, and most preferably from 1 to 10 μm.

### [Fixing of Alignment State of the Liquid Crystal Molecules]

The aligned liquid crystal molecules can be fixed with the alignment state being maintained. Fixing is preferably conducted by means of a polymerization reaction. The polymerization reaction can be a thermal polymerization reaction using a thermal polymerization initiator or a photo polymerization reaction using a photo polymerization initiator. A photo polymerization reaction is preferred.

Examples of the photo polymerization initiator include α-carbonyl compounds (described in U.S. Pat. Nos. 2,367,661 and 2,367,670), acyloin ethers (described in U.S. Pat. No. 2,448,828), α-hydrocarbon-substituted aromatic acyloin compounds (described in U.S. Pat. No. 2,722,512), polynuclear quinone compounds (described in U.S. Pat. Nos. 3,046,127 and 2,951,758), a combination of a triarylimidazole dimer and p-aminophenylketone (described in U.S. Pat. No. 3,549,367), acridine and phenazine compounds (described in Japanese Patent Application Laid-Open No. 60-105667 and U.S. Pat. No. 4,239,850), and oxadiazoles (described in U.S. Pat. No. 4,212,970).

The amount of the photo polymerization initiator to be used is preferably in the range of from 0.01 to 20% by mass, and more preferably from 0.5 to 5% by mass, of the solid component of the coating solution.

UV rays are preferably used for the light irradiation for polymerization of the liquid crystal molecules.

The irradiation energy is preferably in the range of from 20 mJ/cm² to 50 J/cm², more preferably from 20 mJ/cm² to 5,000 mJ/cm², and particularly preferably from 100 mJ/cm² to 800 mJ/cm². In order to accelerate the photo polymerization reaction, UV ray irradiation may be performed under heating conditions.

A protective layer may be provided on the optical anisotropic layer.

It is also preferred to combine this optical compensation film with the polarizing layer. Specifically, an optical anisotropic layer is formed by coating a coating solution to be used for the optical anisotropic layer such as that described above onto a surface of the polarizing film. As a result, a thin polarizing plate which receives only a small stress (distortion×cross section×modulus of elasticity) upon dimensional change of the polarizing film can be obtained without using a polymer film in between the polarizing film and the optical anisotropic layer. When set in a large-sized liquid crystal display device, the polarizing plate according to the present invention can display an image with a high display quality without causing problems such as light leakage.

Stretching is preferably conducted so that the oblique angle between the polarizing layer and the optical compensation layer are the same as the angle formed between the transparent axis of the two polarizing plates laminated on both sides of a liquid crystal cell constituting the LCD and the longitudinal or transverse direction of the liquid crystal cell. The oblique angle is usually 45°. Recently, however, devices wherein the angle is not necessary 45° have been developed for transmissive, reflective, and semi-transmissive LCDs. Thus, it is preferred that the stretching direction can freely be selected in accordance with the design of the LCD.

### [Liquid Crystal Display Device]

The various liquid crystal modes used in such an optical compensation film will now be described.

### (TN-Mode Liquid Crystal Display Device)

TN-mode liquid crystal display devices are most often utilized as color TFT liquid crystal display devices, and are described in many publications. Regarding the alignment state in the liquid crystal cell during TN-mode black display, rod-like liquid crystal molecules are in a standing position in the central portion of the cell and in a lying position in the vicinity of the substrate of the cell.

### (OCR-Mode Liquid Crystal Display Device)

The liquid crystal cell in this device is a bend alignment mode liquid crystal cell wherein rod-like liquid crystal molecules are aligned in substantially reverse directions (symmetrically) between the upper portion and the lower portion of the liquid crystal cell. A liquid crystal display device using the bend alignment mode liquid crystal cell is disclosed in U.S. Pat. Nos. 4,583,825 and 5,410,422. Since the rod-like liquid crystal molecules are symmetrically aligned between the upper portion and the lower portion of the liquid crystal cell, a bend alignment mode liquid crystal cell has a self-optical compensation function. Thus, this liquid crystal mode is also called OCB (Optically Compensated Bend) liquid crystal mode.

Similar to the TN-mode liquid crystal cell, the OCB-mode liquid crystal cell is in an alignment state during black display wherein rod-like liquid crystal molecules are in a standing position in the central portion of the cell and in a lying position in the vicinity of the substrate of the cell.

### (VA-Mode Liquid Crystal Display Device)

VA-mode liquid crystal display devices are wherein the rod-like liquid crystal molecules are substantially vertically aligned when no voltage is applied thereto. VA-mode liquid crystal cells include (1) a VA-mode liquid crystal cell in the narrow sense wherein rod-like liquid crystal molecules are substantially vertically aligned while no voltage is applied thereto and substantially horizontally aligned while voltage is applied thereto (Japanese Patent Application Laid-Open No. 2-176625), (2) an MVA-mode liquid crystal cell wherein VA-mode is modified to be a multi-domain type in order to enlarge the viewing angle (SID 97, Digest of Tech. Papers, 28 (1997), 845), (3) an n-ASM-mode liquid crystal cell described in Japan Liquid Crystal Forum (1998), 58-59, in which rod-like liquid crystal molecules are substantially vertically aligned while voltage is not applied thereto, and the molecules are aligned in a twisted multi-domain alignment while voltage is applied, and (4) a liquid crystal cell of SURVIVAL mode (published in LCD International 98).

### (IPS-Mode Liquid Crystal Display Device)

IPS-mode liquid crystal display devices are wherein the rod-like liquid crystal molecules are aligned substantially horizontally within the plane while voltage is not applied thereto, thereby undergoing change in alignment direction of the liquid crystal according to the application or non-application of voltage to achieve switching. Specific examples which can be used are described in Japanese Patent Application Laid-Open Nos. 2004-365941, 2004-12731, 2004-215620, 2002-221726, 2002-55341, and 2003-195333.

### (Other Liquid Crystal Display Devices)

Optical compensation can also be performed using the concepts described above for ECB mode, STN (Super Twisted Nematic) mode, FLC (Ferroelectric Liquid Crystal) mode, AFLC (Anti-ferroelectric Liquid Crystal) mode, and ASM (Axially Symmetric Aligned Microcell) mode. This is valid for transmissive, reflective or semi-transmissive liquid crystal display devices, and can also be effectively employed for an optical compensation sheet for a GH-type (Guest-Host) reflective liquid crystal display device.

Applications for these above-described fine cellulose derivative films are described in detail at pages 45 to 59 of Journal of Technical Disclosure (Kokai Giho) (Kogi No. 2001-1745, published on Mar. 15, 2001, by Japan Institute of Invention and Innovation).

### [Providing an Anti-Reflective Layer (Anti-Reflective Film)]

The anti-reflective layer generally comprises a layer having a low refractive index (low refractive index layer) which also functions as a stainproof layer and at least one layer having a refractive index higher than that of the low refractive index layer (i.e., a layer having a high refractive index or a layer having a middle refractive index), on a transparent substrate.

Examples of a method for forming a multi-layer film, wherein transparent thin films consisting of inorganic compounds (e.g., metal oxides) having different refractive indexes are laminated one over the other, include chemical vapor deposition (CVD), physical vapor deposition (PVD) and a method of forming a thin film by forming a film of colloidal metal oxide particles through a sol/gel method using a metal compound such as a metal alkoxide, then subjecting to an after-treatment (UV irradiation: Japanese Patent Application Laid-Open No. 9-157855; plasma treatment: Japanese Patent Application Laid-Open No. 2002-327310).

On the other hand, as an anti-reflective layer whose production efficiency is high, various anti-reflective layers have been proposed which are formed by coating a coating solution for forming a thin film containing inorganic particles dispersed in a matrix.

There has also been proposed an anti-reflective film having an anti-reflective layer with anti-glare properties imparted by forming a fine uneven pattern on the uppermost surface of the thus-coated anti-reflective layer.

The cellulose acylate film according to the present invention can be applied in any of the above-described methods, although the coating method (coating type) is particularly preferred.

### [Layer Structure of a Coating Type Anti-Reflective Film]

An anti-reflective layer having at least a middle refractive index layer, a high refractive index layer and a low refractive index layer (outermost layer) on the substrate is designed so that the layers have refractive indexes satisfying the following relationship:

Refractive index of the high refractive index layer>refractive index of the middle refractive index layer>refractive index of the transparent support>refractive index of the low refractive index layer. Further, a hard coat layer may be provided between the transparent support and the middle refractive index layer.

Also, a structure consisting of a middle refractive index hard coat layer, a high refractive index layer and a low refractive index layer may be employed.

Examples of the above are described in Japanese Patent Application Laid-Open Nos. 8-122504, 8-110401, 10-300902, 2002-243906, and 2000-111706. Further, each of the layers may have other additional functions, such as a low refractive index layer having stainproof properties and a high refractive index layer having antistatic properties (e.g., Japanese Patent Application Laid-Open Nos. 10-206603 and 2002-243906).

The haze of the anti-reflective film is preferably 5% or less, and more preferably 3% or less. The hardness of the anti-reflective film is preferably H or more, more preferably 2H or more, and most preferably 3H or more, as measured by the pencil hardness test according to JIS K-5400.

### [High Refractive Index Layer and Middle Refractive Index Layer]

The layer having a high refractive index in the anti-reflective film comprises a curable film containing at least super-fine particles of an inorganic compound of 100 nm or less in average particle size with a high refractive index and a matrix binder.

The inorganic compound fine particles with a high refractive index can be an inorganic compound having a refractive index of 1.65 or more, and more preferably 1.9 or more. Examples thereof include oxides of Ti, Zn, Sb, Sn, Zr, Ce, Ta, La and In, and composite oxides containing these metal atoms.

Methods to obtain the super-fine particles include treating the particle surface with a surface-treating agent (e.g., a silane coupling agent: Japanese Patent Application Laid-Open Nos. 11-295503, 11-153703, and 2000-9908; and an anionic compound or an organometallic coupling agent: Japanese Patent Application Laid-Open No-2001-310432); forming a core-shell structure with a high refractive index particle as a core (Japanese Patent Application Laid-Open No. 2001-166104); using a specific dispersing agent in combination (Japanese Patent Application Laid-Open No. 11-153703, U.S. Pat. No. 6,210,858 B1, and Japanese Patent Application Laid-Open No. 2002-2776069) and the like.

The material for forming the matrix may be a conventionally known thermoplastic resin, curable resin film or the like.

Preferred is at least one composition selected from among compositions, containing a multi-functional compound having at least two radical-polymerizable and/or cation-polymerizable groups and compositions containing an organometallic compound having a hydrolysable group, or partial condensation products thereof. Examples include the compounds described in Japanese Patent Application Laid-Open Nos. 2000-47004, 2001-315242, 2001-31871, and 2001-296401.

Also preferred is a curable film obtained from a colloidal metal oxide obtained from a hydrolysis condensate of a metal alkoxide, and a metal alkoxide composition, as described in, for example, Japanese Patent Application Laid-Open No. 2001-293818.

The refractive index of the high refractive index layer is generally from 1.70 to 2.20. The thickness of the high refractive index layer is preferably from 5 nm to 10 μm, and more preferably from 10 nm to 1 μm.

The refractive index of the middle refractive index layer is adjusted to be a value between the refractive index of the low refractive index layer and the refractive index of the high refractive index layer. The refractive index of the middle refractive index layer is preferably from 1.50 to 1.70.

### [Low Refractive Index Layer]

The low refractive index layer is in turn laminated on the high refractive index layer. The refractive index of the low refractive index layer is from 1.20 to 1.55, and preferably from 1.30 to 1.50.

The low refractive index layer is preferably constituted as an outermost layer having scratch-resistant properties and stainproof properties. As a technique to remarkably improve scratch-resistant properties, it is effective to impart slipping properties to the surface. Such technique can be applied by introduction of a conventionally known silicone or introduction of fluorine into the thin layer.

The refractive index of the fluorine-containing compound is preferably from 1.35 to 1.50, preferably from 1.36 to 1.47. The fluorine-containing compound is preferably a compound containing a cross-linkable or polymerizable functional group containing fluorine atoms in the range of from 35% to 80% by mass.

Examples thereof include compounds described in Japanese Patent Application Laid-Open No. 9-222503, paragraphs [0018] to [0026], Japanese Patent Application Laid-Open No. 11-38202, paragraphs [0019] to [0030], Japanese Patent Application Laid-Open No. 2001-40284, paragraphs [0027] and [0028] and Japanese Patent Application Laid-Open No. 2000-284102.

The silicone compound is preferably a compound having a polysiloxane structure, wherein a curable functional group or a polymerizable functional group is contained in the high polymer chain, and which forms a cross-linking structure in the film. Examples include reactive silicones (e.g., Silaplane, manufactured by Chisso Corporation), and polysiloxanes having silanol group at each end (Japanese Patent Application Laid-Open No. 11-258403).

The cross-linking reaction or polymerization reaction of a fluorine-containing compound and/or siloxane compound having a cross-linkable or polymerizable functional group with the polymer is preferably conducted by irradiating with light or heating simultaneously with, or after, coating a coating composition for forming the outermost layer containing a polymerization initiator or a sensitizing agent.

Also preferred is a sol/gel curable film which is cured by a condensation reaction between an organometallic compound such as a silane coupling agent and a silane coupling agent having a specific fluorine-containing hydrocarbon group in the presence of a catalyst.

Examples thereof include silane compounds having a polyfluoroalkyl group or the partially hydrolyzed condensation product thereof (compounds described in, e.g., Japanese Patent Application Laid-Open Nos. 58-142958, 58-147483, 58-147484, 9-157582, and 11-106704), and silyl compounds having a fluorine-containing long chain group of a poly(perfluoroalkyl ether) group (compounds described in Japanese Patent Application Laid-Open Nos. 2000-117902, 2001-48590, and 2002-53804).

The low refractive index layer can contain, as additives other than those described above, a filler (e.g., low refractive index inorganic compounds having an average primary particle size of from 1 nm to 150 nm, such as silicon dioxide (silica), fluorine-containing particles (e.g., magnesium fluoride, calcium fluoride or barium fluoride), and organic fine particles described in Japanese Patent Application Laid-Open No. 11-3820, paragraphs [0020] to [0038]), a silane coupling agent, a slip agent, a surfactant and the like.

When the low refractive index layer is positioned under the outermost layer, the low refractive index layer may be formed by a gas phase method (e.g., vacuum vapor deposition, sputtering, ion plating or plasma CVD). A coating method is preferred because of its low production costs.

The thickness of the low refractive index layer is preferably from 30 nm to 200 nm, more preferably from 50 nm to 150 nm, and most preferably from 60 nm to 120 nm.

### [Hard Coat Layer]

The hard coat layer is provided on the surface of the stretched or non-stretched cellulose acylate film in order to impart physical strength to the anti-reflective film. It is particularly preferred to provide the hard coat layer between the stretched or non-stretched cellulose acylate film and the high refractive index layer. It is also preferred to directly conduct coating onto the stretched or non-stretched cellulose acylate film without providing an anti-reflective layer.

The hard coat Layer is preferably formed by a cross-linking reaction or a polymerization reaction of a light- and/or heat-curable compound. Preferable examples of the curable functional group include a photo-polymerizable functional group, while the organometallic compound having a hydrolysable functional group is preferably an organic alkoxysilyl compound.

Specific examples of such compounds include those exemplified for the high refractive index layer.

The specific composition constituting the hard coat layer can be such as those described in, for example, Japanese Patent Application Laid-Open Nos. 2002-144913, 2000-9908, and WO 00/46617.

The high refractive index layer can also function as the hard coat layer. In such a case, it is preferred to form the layer by incorporating fine particles in the hard coat layer in a finely dispersed state using a method described with respect to the high refractive index layer.

The hard coat layer can also function as an anti-glare layer (described below) having an anti-glare-function when particles of from 0.2 to 10 μm in average particle size are incorporated therein.

The thickness of the hard coat layer can properly be designed depending upon use. The thickness of the hard coat layer is preferably from 0.2 to 10 μm, and more preferably from 0.5 to 7 μm.

The hardness of the hard coat layer is preferably H or more, more preferably 2H or more, and most preferably 3H or more, as measured by the pencil hardness test according to JIS K-5400. Further, the abrasion loss of a test piece before and after being tested by Taber's abrasion resistance test according to JIS K-5400 is preferably as small as possible.

### [Forward Scattering Layer]

The forward scattering layer is provided for the purpose of improving viewing angle when the visual angle is slanted up or down, left or right, when applied to a liquid crystal display device. The hard coat layer can also function as the forward scattering layer when fine particles having a different refractive index are dispersed in the hard coat layer.

Examples of a forward scattering layer include those having a specific forward scattering coefficient (described in Japanese Patent Application Laid-Open No. 11-38208), those wherein the relative refractive index between the transparent resin and the fine particles is adjusted to a specific range (described in Japanese Patent Application Laid-Open No. 2000-199809), and those whose haze value is specified to be 40% or more (described in Japanese Patent Application Laid-Open No. 2002-107512).

### [Other Layers]

In addition to the above-described layers, there may be provided a primer layer, an antistatic layer, an undercoat layer and a protective layer.

### [Coating Method]

Each of the layers of the anti-reflective film can be formed by coating according to a dip coating method, an air knife coating method, a curtain coating method, a roller coating method, a wire bar coating method, a gravure coating method, a micro-gravure coating method or an extrusion coating method (U.S. Pat. No. 2,681,294).

### [Anti-Glare Function]

The anti-reflective film may have an anti-glare function for scattering external light. The anti-glare function can be obtained by forming uneven portions on the surface of the anti-reflective film. If the anti-reflective film has an anti-glare function, the haze of the anti-reflective film is preferably from 3% to 30%, more preferably from 5% to 20%, and most preferably from 7% to 20%.

As a method for forming uneven portions on the surface of the anti-reflective film, any method may be employed that can adequately maintain such a surface shape. Examples include forming uneven portions on a film surface by using fine particles in the low refractive index layer (e.g., Japanese Patent Application Laid-Open No. 2000-271878); adding comparatively large particles (0.05 to 2 μm in particle size) to a layer under the low refractive index layer (high refractive index layer, middle refractive index layer or hard coat layer) in a comparatively small amount (from 0.1% to 50% by mass) to form a surface-uneven film, and providing a low refractive index layer while maintaining the uneven portions (e.g., Japanese Patent Application Laid-Open Nos. 2000-281410, 2000-95893, 2001-100004, and 2001-281407); and, after providing the outermost layer (stainproof layer), physically transferring an uneven shape onto the surface (e.g. the embossing method described in Japanese Patent Application Laid-Open Nos. S63-278839, H11-183710, and 2000-275401).

### [Applications]

The non-stretched or stretched cellulose acylate film according to the present invention is effective as an optical film, especially as a protective film for the polarizing plate, as a liquid crystal display device optical compensation sheet (also called “phase difference film”), as the optical compensation sheet of a reflective liquid crystal display device, and as a support used for a silver halide photosensitive material.

The measurement methods used in the present invention will now be described.

### (1) Elastic Modulus

Elastic modulus was determined by measuring the stress in a 23° C., 70% rh atmosphere, at a stretching rate of 10%/min for a 0.5% stretch. Measurement was carried out for the MD and TD, and the average value of these was taken as the elastic modulus.

### (2) Degree of Substitution of Cellulose Acylate

The degree of substitution of the respective acyl groups of the cellulose acylate and degree of substitution at their 6-position were obtained by ¹³C-NMR according to the method of Tezuka at al., Carbohydr. Res., 273 (1995) 83-91.

### (3) Residual Solvent

A solution in which 300 mg of a sample film was dissolved in 30 mL of methyl acetate (Sample A), and a solution in which 300 mg of a sample film was dissolved in 30 mL of dichloromethane (Sample 13) were prepared.

These samples were measured under the following conditions using gas chromatography (GC).

Column: DB-WAX (0.25 mm diameter×30 m, film thickness 0.25 μm)

Column Temperature: 50° C.

Carrier Case: Nitrogen

Analysis Time: 15 minutes

Sample Injection Amount: 1 μmL

The solvent amount was determined by the following method.

For sample A, the contents were determined using the analytical curve for each of the peaks other than the solvent (methyl acetate), and the sum thereof was taken as Sa.

For sample B, the contents were determined using the analytical curve for each of the peaks in the region hidden by the solvent peak in sample A, and the sum thereof was taken as Sb.

The sum of Sa and Sb was taken as the residual solvent amount.

### (4) Heat Loss Ratio at 220° C.

Using the TG-DTA2000S manufactured by Mac Science Co., Ltd., the weight change of a 10 mg sample at 220° C. when the sample was heated from room temperature to 400° C. at a temperature increase rate of 10° C./minute under a nitrogen gas atmosphere was taken as the heat loss ratio.

### (5) Melt Viscosity

Melt viscosity was measured under the following conditions using a viscometer using a cone-plate (e.g., the modular compact rheometer: Physica MCR301, manufactured by Anton Paar GmbH).

A resin was thoroughly dried to contain 0.1% or less of water, and then measurement was conducted with a gap of 500 μm at a temperature of 220° C. and a shearing rate (1/sec).

### (6) Re and Rth

Ten points were sampled at equidistant intervals in a width direction of the film. After subjecting the film to wetting for 4 hours at 25° C. and 60% rh, the in-plane retardation value (Re) and retardation value (Rth) in the film-thickness direction were calculated at 25° C. and 60% rh by measuring the phase difference value for a wavelength of 590 nm from a direction slanted in 10° increments from +50° to −50° from the film normal line with the perpendicular direction with respect to the sample film surface and the slow axis serving as the rotation axes using an automatic birefringence analyzer (“KOBRA-21ADH”, manufactured by Oji Scientific Instruments).

### (Saturated Norbornene Resin)

Examples of the saturated norbornene resin used in the present invention include: (1) resins produced by optionally subjecting a norbornene monomer ring-opening (co)polymer to polymer modification, such as maleic acid addition or cyclopentadiene addition, and then hydrogenating the resultant product; (2) resins produced by addition polymerization of norbornene monomers; and (3) resins produced by addition copolymerization of a norbornene monomer with ethylene or an olefin monomer such as α-olefin. The polymerization method and hydrogenation method may be conducted by an ordinary method.

Examples of norbornene monomers include norbornene, alkyl and/or alkylidene substitution products thereof such as 5-methyl-2-norbornene, 5-dimethyl-2-norbornene, 5-ethyl-2-norbornene, 5-butyl-2-norbornene, and 5-ethylidene-2-norbornene, and substitution products thereof with a polar group such as a halogen; dicyclopentadiene, 2,3-dihydrodicyclopentadiene and the like; dimetanooctahydro-naphthalene and alkyl and/or alkylidene substitution products thereof and substitution products with a polar group such as a halogen, such as 6-methyl-1,4:5,8-dimetano-1,4,4a,5,6,7,8,8a-octahydronaphthalene, 6-ethyl-1,4:5,8-dimetano-1,4,4a,5,6,7,8,-8a-octahydronaphthalene, 6-ethylidene-1,4:5,8-dimetano-1,4,4a,5,6,7,8,8a-octahydronaphthalene, 6-chloro-1,4:5,8-dimetano-1,4,4a,5,6,7,8,8a-octahydronaphthalene, 6-cyano-1,4:5,8-dimetano-1,4,-4a,5,6,7,8,8a-octahydronaphthalene, 6-pyridyl-1,4:5,8-dimetano-1,4,4a,5,6,7,8,8a-octahydronaphthalene, and 6-methoxycarbonyl-1,4:5,8-dimetano-1,4,4a,5,6,7,8,8a-octahydronaphthalene; adducts of cyclopentadiene and teterahydroindene and the like; trimers to tetramers of cyclopentadiene, such as 4,9:5,8-dimetano-3a,4,4a,5,8,8a,9,9a-octahydro-1H-benzoindene and 4,11:5,10:6,9-trimetano-3a,4,4a,5,5a,6,9,9a,10,10a,11,11a-dodecahydro-1H-cyclopentaanthracene and the like.

In the present invention, another cycloolefin which is capable of ring opening polymerization may be used together to the extent that the object of the present invention is not harmed. Specific examples of such a cycloolefin include compounds having one reactive double bond, such as cyclopentene, cyclooctene, and 5,6-dihydrodicyclopentadiene.

The saturated norbornene resin used in the present invention has a number average molecular weight measured by gel permeation chromatography (GPC) using a toluene solvent in the range of 25,000 to 100,000, preferably 30,000 to 80,000, and more preferably 35,000 to 70,000. If the number average molecular weight is too small, physical strength deteriorates, and if it is too large, operability during molding deteriorates.

In the present invention, the saturated norbornene resin has a glass transition temperature (Tg) of preferably 100° C. or more to 250° C. or less, more preferably 115° C. or more to 220° C. or less, and even more preferably 130° C. or more to 200° C. or less.

The thermoplastic saturated norbornene resin used in the present invention may optionally be incorporated with various additives, such as phenolic or phosphorous-containing antioxidants, antistatic agents, and UV absorbers. Since liquid crystals generally deteriorate by ultraviolet rays, unless some kind of protection means is used, such as laminating with a UV protection film, the thermoplastic saturated norbornene resin is preferably incorporated with a UV absorber. Examples of UV absorbers which can be used include benzophenone UV absorbers, benzotriazole UV absorbers, and acrylonitrile UV absorbers. Among these, benzophenone UV absorbers are preferred. The added amount is usually 10 to 100,000 ppm, and preferably 100 to 10,000 ppm. Further, when the resin is formed into a sheet by solution casting, the thermoplastic saturated norbornene resin is preferably incorporated with a leveling agent to decrease surface roughness. Examples of leveling agents which may be used include leveling agents for coating materials, such as fluorine-containing nonionic surface active agents, special acrylic resin leveling agents and silicone leveling agents. Preferred among them are being those which have good compatibility with the solvent. The added amount of the leveling agent s usually 5 to 50,000 ppm, and preferably 10 to 20,000 ppm.

### (Melt Film-Forming)

### [Saturated Norbornene Film]

Pellets of a saturated norbornene resin are put into a melt extruder, and dehydrated at a temperature of 100° C. or more to 200° C. or less for 1 minute or more to 10 hours or less, and then kneaded and extruded. The kneading can be performed using a single shaft or a twin shaft extruder.

The film may be formed in the same manner as for the above-described cellulose acylate film, except that the melt temperature is 240 to 320° C., more preferably 250 to 310° C., and further preferably 260 to 300° C., and temperature of the casting drum is 80 to 170° C., more preferably 90 or more to 160° C. or less, and further preferably 100 or more to 150° C. or less.

The thickness unevenness of a thermoplastic film formed by the above-described method is, both in the longitudinal direction and the transverse direction, preferably 0% or more to 2% or less, more preferably 0% or more to 1.5% or less, and further preferably 0% or more to 1% or less. The film is stretched by the above-described method to obtain the thermoplastic film of the present invention.

### (Processing of Thermoplastic Film)

The thermoplastic film biaxially stretched by the above-described method may be used alone, in combination with a polarizing plate, or by providing a liquid crystal layer, a layer whose refractivity has been controlled (low reflective layer), and a hard coat layer on the film. This may be achieved by the following steps.

### (i) Surface Treatment

It is possible to improve adhesion between the thermoplastic film and each functional layer (e.g., an undercoat layer or a backing layer) by subjecting the film to a surface treatment. For example, a glow discharge treatment, UV ray irradiation treatment, corona treatment, flame treatment or treatment with an acid or an alkali may be employed. The glow discharge treatment may be a plasma treatment using a low-temperature plasma generated under a low-pressure gas of 10⁻³ to 20 Torr, and a plasma treatment under atmospheric pressure is also preferable. The term “plasma forming gas” refers to a gas in which a plasma is generated under the above-mentioned conditions. Examples thereof include argon, helium, neon, krypton, xenon, nitrogen, carbon dioxide, flons such as tetrafluoromethane, and mixtures thereof. Detailed descriptions thereon are given in Journal of Technical Disclosure (Kokai Giho) (Kogi No. 2001-1745, published on Mar. 15, 2001 by Japan Institute of Invention and Innovation) on pages 30 to 32. Additionally, plasma treatment under atmospheric pressure which has been noted in recent years employs an irradiation energy of, for example, from 20 to 500 kGy under 10 to 1,000 keV, and more preferably from 20 to 300 kGy under 30 to 500 keV.

Of them, for the case of the saturated norbornene film, especially preferable are glow discharge treatment, corona treatment, and flame treatment.

The surface treatment and the undercoating step can be provided at the final stage of the film-production process, and may be conducted independently or during the step of providing a functional layer to be described hereinafter.

(ii) Functional layer Provision

It is preferred to combine the thermoplastic film of the present invention with functional layers as described in detail in Journal of Technical Disclosure (Kokai Giho) (Kogi No. 2001-1745, published by Japan Institute of Invention and Innovation on Mar. 15, 2001) on pages 32 to 45. Preferable among such layers are a polarizing layer (to form a polarizing plate), an optical compensation layer (to form an optical compensation sheet), and an antireflective layer (to form an antireflective film).

The characteristics of the present invention will now be described in more detail with reference to the following examples and comparative examples. The materials, used amounts, ratios, treatment order and the like described in the following examples can be changed appropriately to the extent that such changes do not depart from the intent of the present invention. Therefore, the scope of the present invention is not to be construed as being limited to the specific examples which are illustrated below.

### EXAMPLES

### 1. Formation of a Cellulose Acylate Film or a Saturated Norbornene Resin Film

### (1) Preparation of Cellulose Acylate

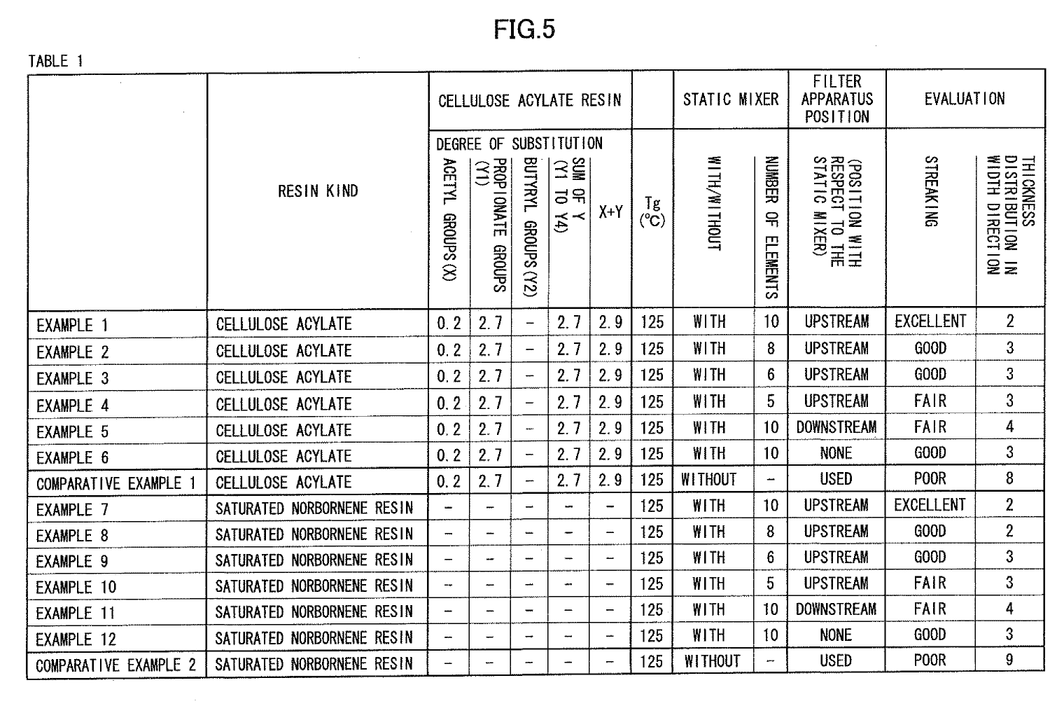

The cellulose acylates described in Table 1 of FIG. 5 were prepared. This was carried out by conducting an acylation reaction at 40° C. by adding sulfuric acid as a catalyst (7.8 parts by weight based on 100 parts by weight of cellulose), and then adding a carboxylic acid serving as a raw material for an acyl substituent. At this stage, the type and degree of substitution of the acyl group were controlled by controlling the type and amount of the carboxylic acid. Further, after the acylation reaction, ripening was performed at 40° C. to prepare a sample (the polymerization degree decreases by lengthening the ripening time). The polymerization degrees of the resultant cellulose acylates were determined by the following methods

### (Polymerization Degree Determination)

About 0.2 g of completely dried cellulose acylate was accurately weighed and dissolved in 100 mL of a methylene chloride:ethanol=9:1 (mass ratio) mixed solvent. The drop number of seconds was measured at 25° C. using an Ostwald viscosimeter. The polymerization degree was determined according to the following equation:

ηrel=T/T0 T: Drop number of seconds of the measurement sample

[η]═(1 nηrel)/C T0: Drop number of seconds of the solvent alone

DP=[η]/Km C: Concentration (g/L)
Km: 6×10⁻⁴

### (2) Cellulose Acylate Pelletization

The above-described cellulose acylate, a plasticizer, a stabilizer, and an optical anisotropy controller, were dried for 3 hours at 100° C. so that the water content was 0.1 wt. % or less Further, 0.05 wt. % of silicon dioxide particles (Aerosil R972V), a UV absorber (0.05 wt. % of 2-(2′-hydroxy-3′,5-di-t-butylphenyl)-benzotriazole and 0.1% of 2,4-hydroxy-4-methoxy-benzophenone) were added thereto.

Plasticizer: Polyethylene glycol (molecular weight 600)
Stabilizer: Bis(2,6-di-t-butyl-4-methylphenyl)pentaerythritol diphosphite
Optical anisotropy controller:

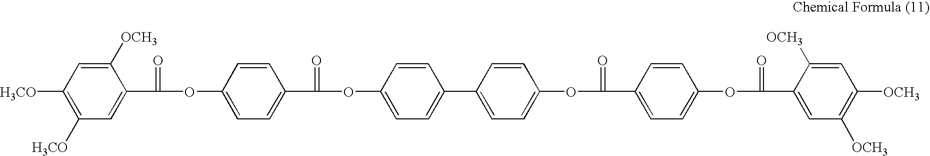

Then, using a biaxial kneading extruder equipped with an evacuator, the mixture was extruded from the die at a screw revolution rate of 300 rpm, a kneading time of 40 seconds, and an extrusion amount of 200 kg/hr. The extruded resin was cooled in water at 60° C., and then cut to obtain cylindrical pellets with a diameter of 2 mm and a length of 3 mm,

### (3) Melt-Formed Film

A cellulose acylate pellet prepared in the above manner or a saturated norbornene resin pellet (APL6013T (Tg 125° C.), manufactured by Mitsui Chemicals Inc.) was dried with dehumidified air having a dew point of −40° C. at 100° C. for 5 hours so as to have a water content of 0.01 wt. % or less. The resultant pellet was charged into an 80° C. hopper. The temperature of the melt extruder and the die were prepared. Here, the diameter (outlet side) of the used screw was 60 mm, L/D=50, and the compression ratio was 4. An oil of the pellets having a Tg of −5° C. was circulated inside the screw of the extruder to cool the inlet side of the screw. The residence time of the resin pellets inside the barrel was set at 5 minutes. The barrel outlet and inlet were respectively set at the maximum temperature and the minimum temperature of the barrel. The resin extruded from the extruder was discharged in a constant amount measured with a gear pump. At this stage, the revolution rate of the extruder was adjusted so that the resin pressure before the gear pump could be controlled at a constant pressure of 10 MPa. The melt resin discharged from the gear pump was, except for Examples 6 and 12, filtered with a leaf disc filter having a filtration precision of 5 μm, extruded from a hanger coat die with a slit interval of 0.8 mm, and then solidified by a casting drum. At this stage, 10 cm on both edges of the melt film was subjected to electrostatic application using an electrostatic application method (a 10 kV wire was arranged at a position of 10 cm from the position for casting onto a casting drum of the melt). The solidified melt was peeled off from the casting drum, and trimmed on both edges (respectively 5% of the total width) just prior to being taken up. The melt film was subjected to a thickening process (knurling) to have a 10 mm wide, 50 mm high thick portion on both edges, and 3000 m was wound up at 30 m/min. The resultant non-stretched film had a width of 1.5 m.

It is noted that in Examples 1 to 4 and 7 to 10, as illustrated in Table 1, the melt resin extruded from the gear pump was filtered by the leaf disc filter, and then fed to the hanger coater die via a static mixer. Further, in Examples 5 and 1, as illustrated in Table 1 of FIG. 5, the melt resin passed through the static mixer, was then filtered by the leaf disc filter, and fed to the hanger coater die. Further, the number of elements of the static mixer at thus stage is as illustrated in Table 1.

### (4) Evaluation of the Melt-Formed Film (Non-Stretched)

The Tg of the thus-obtained cellulose acylate films or saturated norbornene resin films was measured according to the following method, and the results are shown in Table 1.

### (Tg Measurement)

A 20 mg sample was placed on the measuring pan of a DSC. The temperature of this sample was raised from 30° C. to 250° C. at 10° C. per minute in a nitrogen flow (first run), and then cooled to 30° C. at −10° C. per minute. The temperature was then again raised from 30° C. to 250° C. (second run). The Tg determined in the second run (the temperature at which the base line began to inflect from the low temperature side) is shown in FIG. 5.

As can be seen from Table 1 of FIG. 5, in Examples 1 to 12, since a static mixer was provided and the melt resins were statically stirred, streaking was evaluated from Fair to Excellent. In contrast, in Comparative Examples 1 and 2, in which a static mixer was not provided, streaking was evaluated as Poor, and the thickness distribution in the width direction was also larger. Further, from Examples 1 to 4 and 7 to 10, although streaking was evaluated as a C for five elements, for six or more elements streaking was evaluated from Good to Excellent. From this, it can be seen that it is preferred to have six or more elements. In addition, from Examples 1, 5, and 6, and Examples 7, 11, and 12, it can be seen that when a leaf disc filter is provided, it is preferred to arrange it upstream of the static mixer.

Further, the streaking evaluation was carried out by visually examining the appearance of the obtained films. In cases where a film had no streaking it was evaluated as Excellent, if the film had next to no streaking it was evaluated as Good, if the film had a level of streaking which would not be a problem for use in optical applications as a film it was evaluated as Fair, and if the film had a level of streaking which would be a problem for use in optical applications as a film it was evaluated as Poor.

### (5) Preparation of a Polarizing Plate

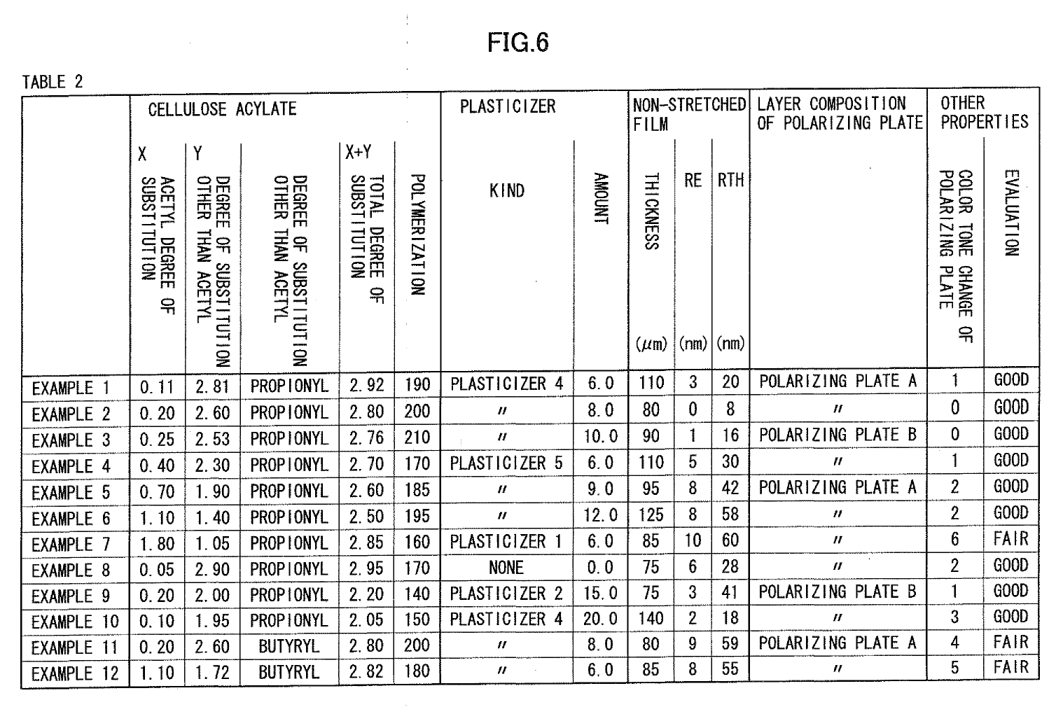

Non-stretched films having different film materials as described in Table 2 of FIG. 6 (degree of substitution, polymerization degree, and plasticizer; plasticizer 1: biphenyldiphenylphosphate; plasticizer 2; dioctyl adipate; plasticizer 3: glycerin diacetate monooleate; plasticizer 4: polyethylene glycol (molecular weight 600)) were produced under the production conditions of Example 1 of Table 1 of FIG. 5 (which can be considered as a best mode for a cellulose acylate film), to prepare the following polarizing plates.

### (5-1) Saponification of Cellulose Acylate Films

The non-stretched cellulose acylate films were saponified by dip saponification described below. Almost the same results were obtained for the non-stretched cellulose acylate films saponified by the below-described coating saponification.

### (i) Coating Saponification

80 parts by mass of isopropanol was charged with 20 parts by mass of water, and KOH was dissolved in the resultant solution to produce a 2.5 normal solution. The temperature of the solution was adjusted to 60° C., and the resultant solution was used as a saponifying solution.

The saponifying solution was applied to the cellulose acylate film at 60° C. in an amount of 10 g/m², and the cellulose acylate film underwent saponification for 1 minute. Then, the saponified cellulose acylate film was spray washed with hot water spray at 50° C. at a spraying rate of 10 L/m² per minute for 1 minute.

### (ii) Dip Saponification

A 2.5 N aqueous solution of NaOH was used as a saponifying solution.

This solution was adjusted to a temperature of 60° C., and a cellulose acylate film was dipped therein for 2 minutes.

Then, the film was dipped in a 0.1 N aqueous solution of sulfuric acid for 30 seconds, and passed through a water-washing bath.

### (5-2) Preparation of a Polarizing Layer

The film was stretched in a longitudinal direction by applying a difference in peripheral speed between two pairs of nip rolls according to Example 1 in Japanese Patent Application Laid-Open No. 200′-141926, whereby a 20 μm thick polarizing layer was prepared.

### (5-3) Lamination

The thus-obtained polarizing layer, the above-described saponification-treated non-stretched and stretched cellulose acylate films, and saponification-treated FUJI TAC (non-stretched triacetate film) were laminated in the following combination in the stretching direction of the polarizing film and in the film-forming flow direction (longitudinal direction) of the cellulose acylate using a 3% PVA aqueous solution (PVA-117H; manufactured by Kuraray Co. Ltd.) as an adhesive.

Polarizing Plate A: Non-stretched cellulose acylate film/polarizing layer/FUJI TAC

Polarizing Plate B: Non-stretched cellulose acylate film/polarizing layer/non-stretched cellulose acylate film

### (5-4) Color Tone Change of the Polarizing Plate

The magnitude of color tone change of the thus-obtained polarizing plates was evaluated on a ten-point scale (the higher the value, the greater the color tone change). The polarizing plates produced according to the present invention were all evaluated as good.

### (5-5) Evaluation of Moisture Curl

The thus-obtained polarizing plates were measured according to the above-described method. Even after being processed into polarizing plates, the polarizing plates according to the present invention all exhibited good properties (low moisture curl).

Further, polarizing plates were also prepared by laminating so that the polarizing axis and the longitudinal direction of the cellulose acylate film were orthogonally at 45 degrees to each other, and then evaluated in the same manner. All of the polarizing plates had the same results as when parallelly laminated.

### (6) Preparation of Optical Compensation Film and Liquid Crystal Element

The polarizing plate on the viewer's side provided on a 22-inch liquid crystal display device (manufactured by Sharp Corporation) using VA-type liquid cells was peeled off, and in the case of the above-described retardation polarizing plates A and B, the polarizing plate was removed and then laminated on the viewer's side via an adhesive so that the cellulose acylate film was on the liquid crystal cell side. The liquid crystal display device was produced so that the transmission axis of the polarizing plate of the viewer's side and the transmission axis of the backlight side were orthogonal.

In this case as well, when the present invention was used moisture curl was small, lamination was simple, and misalignment during lamination was low.

Further, a good optical compensation film with little moisture curl can be prepared even if the cellulose acylate film according to the present invention is used instead of the cellulose acylate film coated with a liquid crystal layer of Example 1 of Japanese Patent Application Laid-Open No. 11-316378.

A good optical compensation film with little moisture curl can also be prepared even if an optical compensation filter film is prepared by using the cellulose acylate film according to the present invention instead of the cellulose acetate film coated with the liquid crystal layer of Example 1 in Japanese Patent Application Laid-Open No. 7-333433.

Further, a good liquid crystal display device with little moisture curl was obtained when the polarizing plate and the retardation polarizing plate according to the present invention were employed in the liquid crystal display device described in Example 1 of Japanese Patent Application Laid-Open No. 10-48420, the alignment film coated with polyvinyl alcohol and an optical anisotropic layer containing discotic liquid crystal molecules described in Example 1 of Japanese Patent Application Laid-Open No. 9-26572, the 20-inch VA-type liquid crystal display device described in FIGS. 2 to 9 of Japanese Patent Application Laid-Open No. 2000-154261, the 20-inch OCB-type liquid crystal display device described in FIGS. 10 to 15 of Japanese Patent Application Laid-Open No. 2000-154261, and the IPS-type liquid crystal display device described in FIG. 11 of Japanese Patent Application Laid-Open No. 2004-12731.

### (7) Preparation of an Anti-Reflective Film

Low-reflection films were prepared by using the cellulose acylate film according to the present invention according to Example 47 of Journal of Technical Disclosure (Kokai Giho) (Kogi No. 2001-1745). The moisture curl of this film was measured according to the above method. The low-reflection film employing the present invention obtained good results the same as for the polarizing plate.

Further, a good liquid crystal display device was obtained when the low-reflection film according to the present invention was evaluated after sticking onto the uppermost layer of the liquid crystal liquid crystal display device described in Example 1 of Japanese Patent Application Laid-Open No. 10-48420, the 20-inch VA-type liquid crystal display device described in FIGS. 2 to 9 of Japanese Patent Application Laid-Open No. 2000-154261, the 20-inch OCB-type liquid crystal display device described in FIGS. 10 to 15 of Japanese Patent Application Laid-Open No. 2000-154261, and the IPS-type liquid crystal display device described in FIG. 11 of Japanese Patent Application Laid-Open No. 2004-12731.

1-9. (canceled)

10. A process for producing a cellulose acylate film, including:
melting a cellulose acylate resin in an extruder,
supplying the melt resin to a die via a pipe, statically stirring the melt resin flowing through the pipe by providing a static mixer in the pipe, discharging the resin from the die in sheet form onto a running or a rotating cooling support, and quenching and solidifying the sheet so as to form the cellulose acylate film.

11. The process for producing a cellulose acylate film according to claim 10, wherein the static mixer has six or more elements.

12. The process for producing a cellulose acylate film according to claim 10, wherein the pipe is provided with a filter apparatus comprising a leaf disc filter, and the filter apparatus is provided upstream of the static mixer.

13. A cellulose acylate film produced by the production process according to claim 10.

14. The cellulose acylate film according to claim 13, wherein
when X represents the degree of substitution of an acetyl group, and Y represents the sum of the degree of substitution of a propionyl group, a butyryl group, a pentanoyl group and a hexanoyl group, the cellulose acylate resin has an acylate group which satisfies the following degree of substitution:
2.0≦X+Y≦3.0;
0≦X≦2.0; and
1.2≦Y+B≦2.9.

15. A process for producing a saturated norbornene resin film, including:
melting a saturated norbornene resin in an extruder, supplying the melt resin to a die via a pipe, discharging the resin from the die in sheet form onto a running or a rotating cooling support, statically stirring the melt resin flowing through the pipe by providing a static mixer in the pipe, and quenching and solidifying the sheet so as to form saturated norbornene resin film.

16. The process for producing a saturated norbornene resin film according to claim 15, wherein the static mixer has six or more elements.

17. The process for producing a saturated norbornene resin film according to claim 15, wherein the pipe is provided with a filter apparatus comprising a leaf disc filter, and the filter apparatus is provided upstream of the static mixer.

18. A saturated norbornene resin film produced by the production process according to claim 15.

19. The process for producing a cellulose acylate film according to claim 11, wherein the pipe is provided with a filter apparatus comprising a leaf disc filter, and the filter apparatus is provided upstream of the static mixer.

20. A cellulose acylate film produced by the production process according to claim 11.

21. A cellulose acylate film produced by the production process according to claim 12.

22. The process for producing a saturated norbornene resin film according to claim 16, wherein the pipe is provided with a filter apparatus comprising a leaf disc filter, and the filter apparatus is provided upstream of the static mixer.

23. A saturated norbornene resin film produced by the production process—according to claim 16.

24. A saturated norbornene resin film produced by the production process—according to claim 17.
